(19) United States
(12) Patent Application Publication
(10) Pub. No.: US 2004/0025162 A1
(43) Pub. Date: Feb. 5, 2004

(54) Data storage management system and method

(76) Inventor: David C. Fisk, Redondo Beach, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/209,963

(22) Filed: Jul. 31, 2002

(51) Int. Cl. G06F 9/00

(52) U.S. Cl. 718/105

(57) ABSTRACT

The invention relates to methods and associated systems for managing application workloads and data storage resources. Techniques are disclosed for determining the I/O capacity of a data storage resource for a given workload and allocating resources according to administrator requirements. The invention may be implemented as a transparent layer between the application and the data storage resource, for example, in the file system.

### FIELD OF THE INVENTION

The invention relates generally to the field of data storage systems and, more particularly, to systems and methods for managing data storage resources.

### BACKGROUND

The management of a data storage system in a computing system typically involves configuration of the data storage system and allocation of system resources to achieve a desired level of system performance.

In a conventional computing system, application programs (hereafter “applications”) executing on a processor may access data and/or data files stored in a data storage system. For example, a database application operates in conjunction with a database of information that may be stored in a data storage system. During the operation of the database application, various aspects of the application access data in the database.

A data storage system may include one or more data storage components. These components may be distributed throughout a data network. Thus, accesses to a data storage system may involve accesses to several components.

A data storage system may include a data storage manager component that handles requests from applications for data stored in one or more data storage components in a seamless manner. That is, when an application requests data from the data storage system, the application does not need to “know” how or where the data is stored. Thus, the data storage manager may reconfigure how and where data is stored in the data storage system without adversely affecting the application.

Administrators of computing systems continually strive to ensure that their computing systems are as efficient as possible. On the one hand, an administrator must provide sufficient data storage capabilities so that applications executing on a computing system will execute at a reasonable speed. When a system is configured with too many applications vying for the services of the storage system, the response time of the system may be undesirably long because the applications must wait for their turn to access the storage system. On the other hand, an administrator must avoid buying too much storage capability. In this case, the storage system may be under used, resulting in a waste of valuable resources.

The task of allocating physical resources (e.g., disk drives) to logical entities (e.g., application data) is called schema mapping, or logical to physical schema design. One example of a typical schema is: “The employee table of the HR database allocated to tablespace01 on datafile01 on logical volume VOL01, which is a RAID-10.4+4@32 KB device, 500 GB size.” Thus, the schema defines where the logical entity “employee table” will physically reside: “VOL01,” and the size of the disk drive: “500 GB.” It does not, however, address the input/output (“I/O”) capacity of the resource.

An administrator must attempt to ensure that the I/O capacity available in a logical to physical schema (e.g., application to disk drive) is sufficient. Some basic techniques that have been employed in database applications are to separate the data and the index of the database, and to otherwise spread the storage load as evenly as possible. This may include, for example, allocating frequently used data objects to different physical resources.

The complexities of data storage system components present formidable challenges to system administrators. These components may not be well understood and layers of software protocol may obscure their very identity. For example, each layer of software protocol may provide its own name by which the component is known. The use of complex components such as redundant array of independent disks (“RAID”) arrays, storage area network (“SAN”) name servers, storage virtualization devices, host device tree, redundant path name facilities, and host volume management contribute to the storage management problem. The result of this complexity is a high cost of ownership in person-hours spent managing the complexity and in application down time.

Due to the shear size and number of these complex components in use today, it has become difficult for administrators to manage the design and the growth of enterprise applications, let alone optimize the applications. Accordingly, a need exists for improved management techniques for data storage systems.

### SUMMARY

The invention relates to methods and associated systems for managing application workloads and data storage resources. For example, one embodiment of a system constructed according to the invention allocates data storage resources (i.e., hardware and/or software for storing data) to applications to achieve desired levels of system performance. To this end, various embodiments for mapping I/O demand to I/O capacity, determining response times in the system and allocating the application workload and/or system resources are described.

One embodiment of the invention relates to mapping I/O demand in a system to the I/O capacity of the data storage resources in the system to determine the I/O capacity of the data storage resources for a given application workload. Data storage resources have a limited I/O capacity (i.e., the maximum I/O throughput). Moreover, at a given point in time the I/O throughput of a data storage resource depends on the application workload. The application workload may depend, in part, on the number of concurrent requests and the types of data requests in the system.

The number of concurrent requests may affect the response times of the data requests and, thus, may affect the I/O throughput. As the number of concurrent requests increases in a system, the response time for each request will increase once the I/O capacity of the data storage resource has been reached. In other words, beyond this point less I/O throughput will be available for each request.

Different types of data requests may present different loads to a data storage resource. For example the throughput for a random read of 8 kilobytes (“Kbytes”) may differ from the throughput for a random write of 64 Kbytes. In practice, a workload typically is complex. That is, the workload consists of many types of requests. Thus, the throughput of a data storage resource may depend on the complexity of the workload.

In accordance with one embodiment of the invention, techniques are provided for determining the response time of a data storage resource when the data storage resource is servicing a complex workload. First, the effects of individual workloads on the data storage resource are computed over a range of concurrent workload conditions. Second, these effects are then combined using probability distribution data and linear operations to determine a cumulative response time of the resource. Third, an estimate is calculated of the response time for a given workload when the resource is servicing the complex workload.

One embodiment of the invention relates to techniques for allocating the workload and/or the data storage resources to provide a desired level of system performance. Here, an administrator may define desired operating conditions of the system. For example, the administrator may define a maximum utilization level and/or a minimum response time for a given workload when the resource is servicing a complex workload. Using techniques complementary to those discussed above the administrator may then calculate, for example, the number of components of a storage resource over which a given workload should be spread (e.g., divided). In one embodiment this would involve determining a minimum stripe width for a RAID data storage resource. Thus, using these techniques an administrator may determine how to configure the system to provide a desired level of I/O throughput.

One embodiment of the invention relates to a storage management system implemented as a transparent layer between an application and a data storage resource. For example, the storage management system may be implemented in the file system. Thus, the storage management system may track details of the I/O calls and system performance associated with those I/O calls. Accordingly, the storage management system has access to the data and resources needed to determine the I/O capacity of the data storage resource for a given workload and allocate resources according to administrator requirements.

Significantly, the storage management system may be combined with an existing file system. That is, the software for the storage management system need not provide all of the functions of a file system. Rather, the storage management system may be linked to the file system so that file system I/O calls to data storage devices are routed through the storage management system. After collecting information about the I/O calls, the storage management system then, in effect, passes the I/O calls to the data storage devices. Thus, a system constructed according to this embodiment of the invention may be seamlessly integrated into an existing system.

One embodiment of the invention provides a user interface implemented in association with the file system. For example, the user interface may have access to file system resources such as control of data storage resources and/or information related to I/O activity. In this case, an administrator may use the user interface to specify, build and maintain data storage resources to satisfy application requirements, business requirements and user objectives.

One embodiment of the invention relates to a workflow name space that associates workflow processes with business process names. Thus, an administrator may track the use of system resources by, for example, departments in an organization.

### BRIEF DESCRIPTION OF THE DRAWINGS

These and other features, aspects and advantages of the present invention will be more fully understood when considered with respect to the following detailed description, appended claims and accompanying drawings, wherein:

FIG. 1 is a block diagram of one embodiment of a data storage system constructed in accordance with the invention;

FIG. 2 is a flowchart representative of one embodiment of operations that may be performed in accordance with the embodiment of FIG. 1;

FIG. 3 is a block diagram of one embodiment of an encapsulated file system constructed in accordance with the invention;

FIG. 4 is a flowchart representative of one embodiment of operations that may be performed in accordance with the embodiment of FIG. 3;

FIG. 5 is a flowchart representative of one embodiment of user interface operations that may be performed in accordance with the invention;

FIG. 6 is a graphical representation of one embodiment of a workflow name space in accordance with the invention;

FIG. 7 is a graphical representation of one embodiment of a workflow name space in accordance with the invention;

FIG. 8 is a graphical representation of one embodiment of a workflow object load level in accordance with the invention;

FIG. 9 is a graphical representation of one embodiment of a mapping of a unit of work to a unit of storage in accordance with the invention;

FIG. 10 is a graphical representation of one embodiment of a mapping of probability composition/decomposition in accordance with the invention;

FIG. 11 is a graphical representation of one embodiment of a mapping of a probability distribution in accordance with the invention;

FIG. 12 is a block diagram of one embodiment of a data processing system constructed in accordance with the invention;

FIG. 13 is a block diagram of one embodiment of data storage management operational components in accordance with the invention;

FIG. 14 is a block diagram of one embodiment of data storage management operational components in accordance with the invention;

FIG. 15 is a block diagram of one embodiment of data storage management operational components in accordance with the invention;

FIG. 16 is a block diagram of one embodiment of data storage management operational components in accordance with the invention;

FIG. 17 is a block diagram of one embodiment of data storage management operational components in accordance with the invention;

FIG. 18 is a block diagram of one embodiment of data storage management operational components in accordance with the invention;

FIG. 19 is a block diagram of one embodiment of data storage management operational components in accordance with the invention;

FIG. 20 is a block diagram of one embodiment of data storage management operational components in accordance with the invention;

FIG. 21 is a graphical representation of one embodiment of system interface boundaries; and

FIG. 22 is a block diagram of one embodiment of a data storage system constructed in accordance with the invention.

### DETAILED DESCRIPTION OF EMBODIMENTS OF THE INVENTION

The invention is described below, with reference to detailed illustrative embodiments. It will be apparent that the invention can be embodied in a wide variety of forms, some of which may be quite different from those of the disclosed embodiments. Consequently, the specific structural and functional details disclosed herein are merely representative and do not limit the scope of the invention.

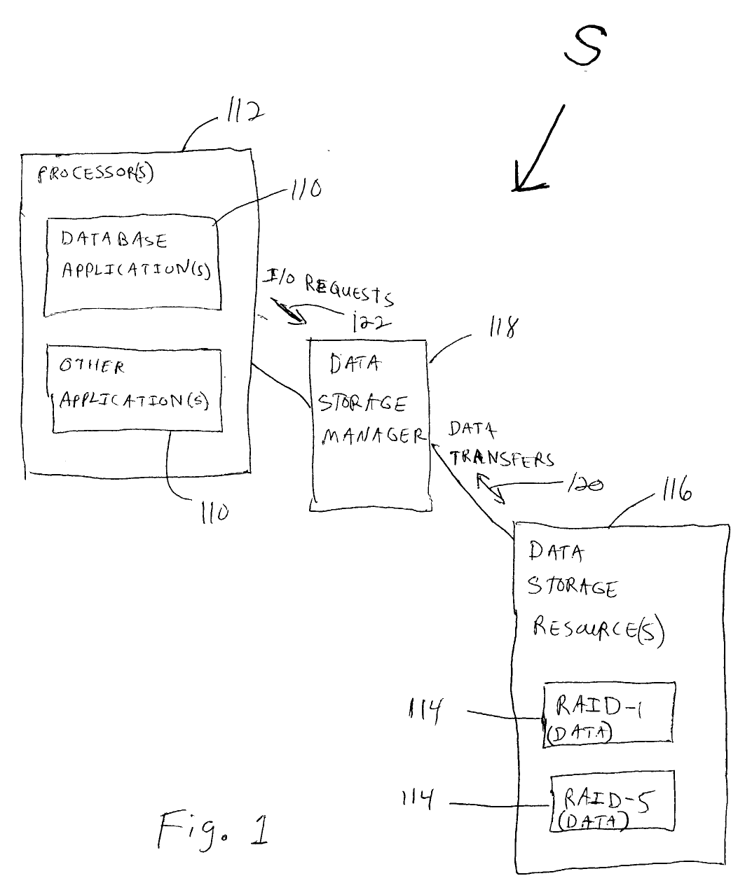

FIG. 1 is a block diagram of one embodiment of a data storage system S constructed in accordance with the invention. Applications 110 executing on one or more processors 112 access data 114 stored in one or more data storage resources 116. A data storage manager 118 controls access to the data 114, monitors the data transfers (as represented by line 120) and allocates data storage resources 116 to the applications 110. The I/O throughput for the data transfers in the system S depends, in part, on the characteristics of the data storage resources 116, the workloads associated with the applications 110 and the number of concurrent I/O requests (represented by line 122) in the system.

A data storage resource 116 consists of hardware and/or software for storing data. For example, data storage resources may include disk arrays, solid state disks, tapes, robots and switches and associated firmware and/or software. Data storage resources also may include software resources in the computing system such as logical volumes, and file system and kernel parameters relative to the I/O subsystem.

A typical storage device as depicted in FIG. 1 consists of a RAID device such as RAID-1 or RAID-5 device. By definition, a RAID device consists of an array of data storage disks. RAID devices may provide relatively high I/O throughput by storing a portion of the data for a given application on each of the disks in the array. Thus, the data storage manager 118 may access the data in parallel, concatenate the data, and send the concatenated data to the application 110. Significant attributes of RAID devices include stripe size and stripe width. In general, stripe size refers to the smallest amount of data stored on a given disk for a stripe. That is, accesses to a disk are made in increments of the stripe size. In general, stripe width refers to the number of parallel disks that are used to store a given unit of data (referred to as a “stripe”). Thus, I/O performance may be improved by using a wider stripe width.

The workload associated with an application depends on the processes being performed by the application. For example, a database application may perform operations related to generating an index of the data items in the database. In addition, the database application may perform operations related to reading data items from and writing data items to the database.

A workload may be characterized, for example, by the types of data accesses associated with each operation. In general, data accesses consist of four types: random read, random write, sequential read and sequential write. In addition, data accesses may read or write different quantities of data. For example, an 8K random read reads 8 Kbytes of data. A 64K random write writes 64 Kbytes of data.

Typically, the amount of time it takes for a data storage resource to complete a request (i.e., the response time for the request) depends on the type of the I/O request. For example, an 8K sequential read may have a faster response time than a 64K random write.

The number of concurrent I/O requests to a data storage resource also may affect the response time of the data storage resource. This is because there is a finite limit on the amount of data that may be read from or written to the data storage resource at a given moment in time. This limit is due in large part to the physical limits on the rate at which data may be read from or written to a disk drive. Accordingly, as the number of concurrent I/O requests to a data storage resource increases, at some point the I/O capacity of the data storage resource may be reached. If the number of concurrent I/O requests continues to increase past this point, some of the I/O requests will be queued to enable the data storage resource to service prior requests. As a result, the response time for completing the I/O requests will increase.

In summary, the response time of a data storage resource for completing an I/O request may depend, in part, on the characteristics of the data storage resource and the number and type of concurrent I/O requests. In other words, I/O capacity is context dependent.

In accordance with one embodiment of the invention, the data storage manager 118 estimates the response time of a workload on a data storage resource servicing a complex workload. A system administrator may use this information to configure the system to provide a desired level of performance.

In accordance with one embodiment of the invention, the data storage manager allows the administrator to define a desired system performance and then estimate, based on system I/O performance, an appropriate mapping of data storage resources to application workload to achieve the desired system performance. For example, a desired level of performance may be achieved by spreading the workload of an application across several data storage devices. The teachings herein may be used to determine, for a given data storage resource and complex workload, the number of data storage devices across which a particular application workload should be spread.

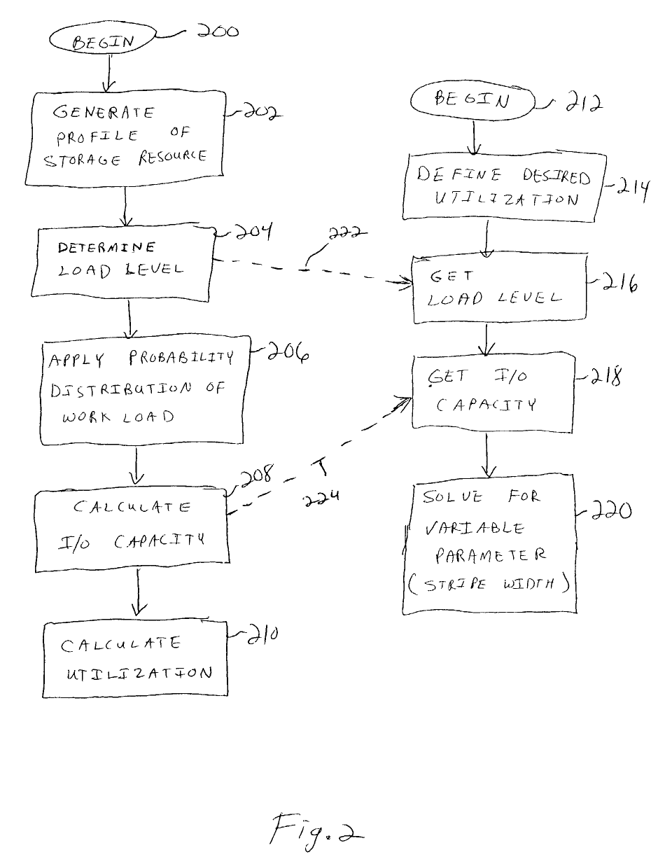

System analysis and configuration operations associated with these embodiments of the invention will be discussed in more detail in conjunction with the flowchart of FIG. 2. Blocks 200-210 represent operations for analyzing response times for complex workloads associated with a data storage resource.

As represented by block 202, the data storage manager 118 analyzes the data storage resource to determine the response characteristics (e.g., response times) of the data storage resource for various workloads. For example, data may be collected over time to determine, on average, how long it takes to complete requests for various data access types such as 8K random reads, 8K sequential writes, etc.

This analysis also may take into account the load level in the system. That is, data may be collected to determine the response characteristics as the number of concurrent requests varies.

The next steps in the flowchart relate to determining the response time for a particular workload under a given set of conditions. As represented by block 204, the data storage manager 118 determines the load level (e.g., average number of concurrent operations) for the analysis. Typically, this is an empirical measurement of the load level in the system. Alternatively, the load level may be selected if, for example, the system is being configured to provide a certain level of performance at that load level.

As represented by block 206, the data storage manager 118 determines the complex probability distribution of the application workload. For example, this may indicate, on average, the percent of the concurrent I/O requests associated with a given workload. To illustrate further, 8K random reads and 8K random writes may, on average, each consume 50% of the I/O capacity of the data storage resource.

As represented by block 208, the data storage manager 118 calculates the I/O capacity of the data storage resource for a given workload. For example, the average arrival rate for 8K random reads on this data storage resource under these conditions may be 100 I/O operations per second (“IOPS”).

Finally, as represented by block 210, the data storage manager 118 calculates the utilization level of the data storage resource 116. The utilization level is a measure of percent of I/O capacity that is being used. It may be calculated, for example, by dividing a measured average IOPS by the estimated IOPS (calculated at block 208).

Blocks 212-220 represent operations for configuring system resources in response to measured response times and/or utilization levels. For example, given a desired system response as described in blocks 200-210, an administrator may wish to determine the RAID stripe width he/she needs to maintain a desired utilization level. As represented by block 214, the administrator defines a desired utilization level and inputs this into the data storage manager 118.

Next, the data storage manager 118 determines the load level in the system (block 216). As represented by the dashed line 222, this may be the same load level determined at block 204. Alternatively, the load level may be specified at this step.

As represented by block 218, the data storage manager 118 determines the I/O capacity of the data storage resource 116. As represented by the dashed line 224, this may be the I/O capacity determined at block 208.

As represented by block 220, the data storage manager 118 calculates the desired parameter. In this example, the parameter is the stripe width necessary to provide a given utilization level. It is possible, however, that a given system may not provide the desired level of performance. In this case, the data storage manager 118 may notify the administrator that the system S may need to be reconfigured. For example, new data storage resources may be added or the data storage resources 116 may be replaced with different data storage resources. In one embodiment, the data storage manager 118 may automatically reconfigure the system S.

In an alternate embodiment, a process similar to that of blocks 212-220 may be used to solve for the load level in the system. For example, given a desired utilization level and data storage resource 116, the data storage manager 118 may determine the number of concurrent streams necessary to support the desired performance. This embodiment may be useful in application(s) where the application(s) may be tuned for a higher level of concurrency.

Encapsulated Storage File System

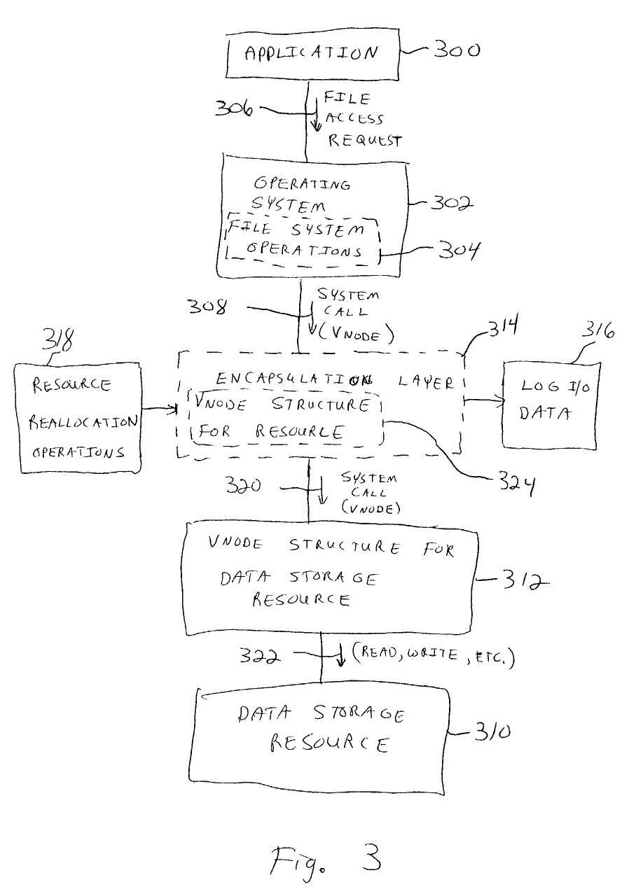

Referring now to FIGS. 3 through 5, an embodiment of the invention referred to as an encapsulated storage file system (“ESFS”) will be discussed. This embodiment relates to the interposition of a user and application transparent layer between the application and real file system or raw device. That is, a user interface and associated storage management application may be integrated into the file system of an operating system. From this position in the operating system kernel, the management application may be seamlessly integrated into existing environments, real-time analysis of application behavior may be tracked, and first tier control of system resources for mapping to the application logical address space may be obtained.

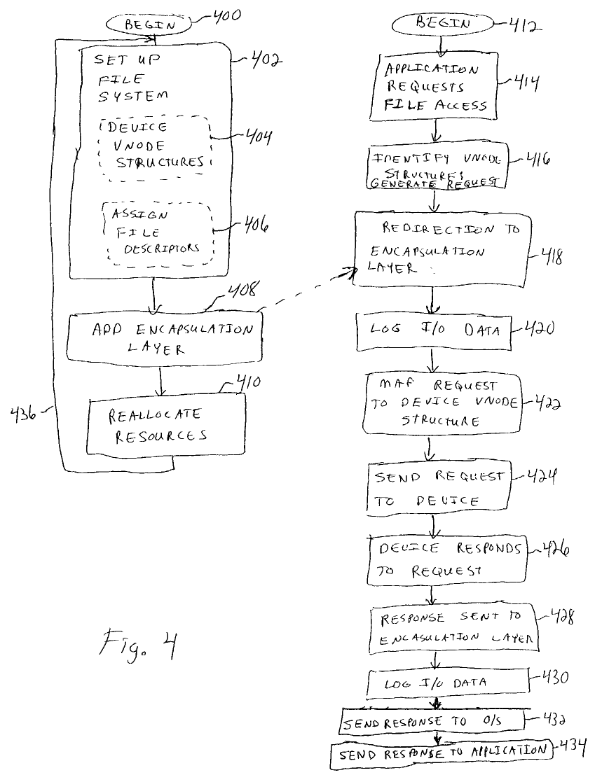

The embodiments of FIGS. 3 and 4 relate to the UNIX abstraction of the Vnode/Vfs interface. The file system, and in particular the UNIX abstraction of the Vnode/Vfs interface, provides a favorable vantage point for the implementation of a comprehensive storage management solution. All storage resources are presented to the application through the file system and, in this sense, all I/O passes through the file system, in the form of accesses to regular files or raw (device) files. The file system may control the mapping of virtual memory to devices, and may have access to the device resources available to the host system, even if those devices have not been integrated into the user accessible device tree. The position of the file system, in the kernel, with full access to kernel resources, located between the user application and the storage resource may provide a preferable implementation location for storage management.

Moreover, the benefits of the file system may be obtained with out incurring all the complexity of a full file system implementation. These benefits may be obtained, for example, by interposition and encapsulation of existing file systems and raw devices with a simple layer between the user and the real file system. This approach has all the advantages, and a minimum of the complexity, characteristic of this layer of the operating system.

In FIG. 3 an operating system 302 controls execution of application programs 300. In addition, file system operations 304 in the operating system handle requests 306 for data storage resources in the system. For example, requests to open, read, write and seek a file are handled by the file system 304.

In accordance with one embodiment of the invention, the system calls 308 from the operating system 302 that would normally be passed to routines associated with a data storage resource 310 are instead redirected to a data storage management application. The data storage management application transparently routes the I/O request to the routines associated with the data storage resource. However, the data storage management application may also log the details of the I/O requests and the system I/O performance associated with the I/O requests. In addition, the data storage management application may allocate different data storage resources to the application to achieve system performance objectives.

The operation of the system of FIG. 3 will be described in more detail in conjunction with the flowchart of FIG. 4. The operations represented by blocks 400-410 relate to operations that may be performed to configure an encapsulated file system.

As represented by block 402, an administrator initially sets up the operating system and associated file system. In addition, when a user accesses or opens a file the operating system defines virtual node (“VNODE”) structures (block 404) and file descriptors (block 406) associated with the file.

As represented by block 408, a data storage management application is incorporated into the system. In one embodiment, this may be implemented with a transparent encapsulation layer process 314 that intercepts, processes or monitors system calls from the file system 304 to data storage resources 310. In one embodiment, system calls associated with the VNODE structure 312 of a data storage resource 310 are mapped to an alternative VNODE structure 324 associated with the encapsulation layer 314. After processing the system call, the encapsulation layer redirects the system call (as represented by line 320) to the VNODE structure 312. Thus, the encapsulation may be transparent in the sense that the system call may, in effect, be routed to the data storage resource without modification.

In addition, as represented by block 410, the data storage management application may perform reallocation operations 318 that reallocate system resources. For example, I/O requests for a given application may be redirected to a different data storage resource. As represented by line 436, this may require reconfiguration at the operating system level.

The operations represented by blocks 412-434 relate to operations that may be performed when the encapsulated file system services I/O requests. As represented by block 414, the application 300 issues a file access request 306 (i.e., system call) that is handled by the file system 304. Typically this request would include a file descriptor that uniquely identifies the desired data resource. Next, the operating system 302 accesses a system file table to determine the VNODE associated with the request (e.g., associated with the file descriptor) and invokes the VNODE operation associated with the system call 308 (block 416). Conventionally, the system call 308 would invoke an operation defined by the VNODE structure 312 for the data storage resource 310.

In accordance with this embodiment of the invention, however, the system call instead invokes an operation defined by the VNODE structure 324 for the encapsulation layer 314 defined at block 408. Thus, the system call 308 is effectively redirected to the encapsulation layer (block 418). The encapsulation layer process monitors I/O information associated with the request and stores the information in a data memory 316 as represented by block 420.

Next, the encapsulation layer 314 invokes the originally intended VNODE operation corresponding to the system call 308. This VNODE operation is associated with the VNODE structure 312 for the data storage resource 310 (block 422).

As a result, the routine specified in the VNODE structure 312 is called and, as represented by block 424, this routine generates a request 322 (e.g., a read or write operation) to the data storage resource 310.

The response of the data storage resource 310 to the request (block 426) is routed back to the operational components discussed above in a manner complementary to the request operations. Thus, the response also may be handled by the encapsulation layer 314 (block 428). In this way, the encapsulation layer 314 may again log information related to the I/O request (block 430).

As represented by blocks 432 and 434, the request is then sent back, in a transparent manner, via the file system 304 to the application 300.

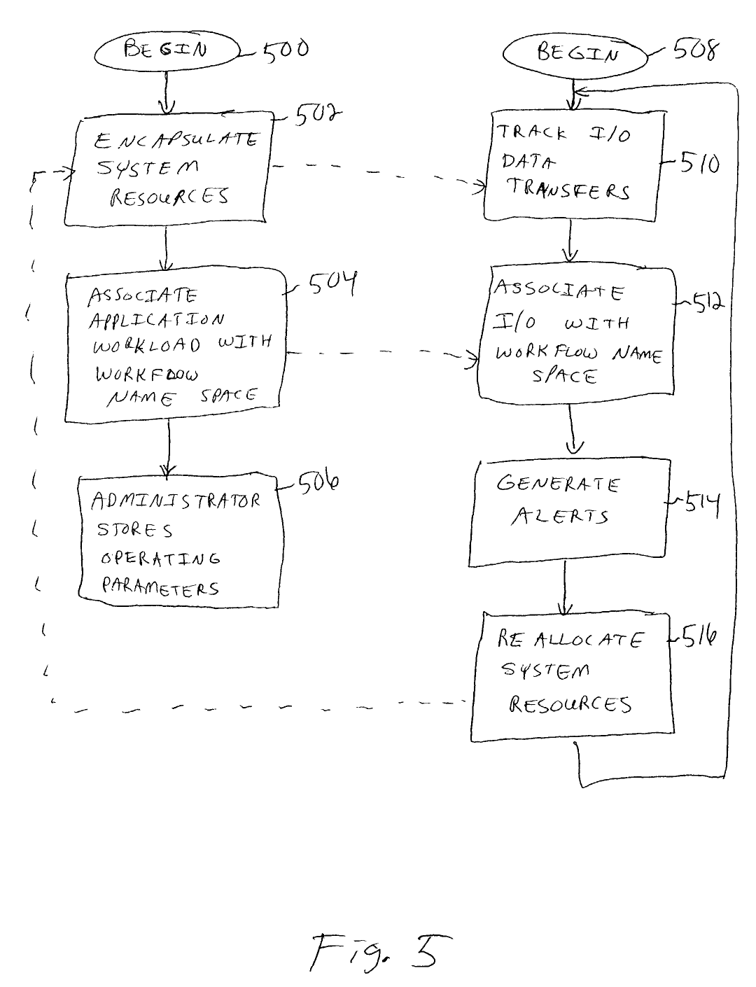

Referring now to FIG. 5, one embodiment of user interface operations performed according to the invention will be discussed. A primary function of the user interface is to associate data storage resources with applications and user policies (e.g., a service level specification as discussed below).

The operations represented by blocks 500-506 relate to operations that may be performed to configure the user interface in an encapsulated file system. As represented by block 502, the user interface may operate in conjunction with encapsulated system resources, for example, as discussed herein.

In addition, as represented by block 504, the user interface may operate in conjunction with a workflow name space. For example, as discussed herein, the workflow name space may be associated with the workload of an application. In this way, workload in a system may be traced to the business processes that use the workload.

As represented by block 506, the user interface enables an administrator to define system parameters. Examples of these parameters are discussed below.

The operations represented by blocks 508-516 relate to real-time user interface operations. As represented by block 510, the encapsulated storage file system may track I/O activity in the system. In addition, this information may be stored in a data memory.

As represented by block 512, this I/O activity may be associated with the workflow name space defined at block 504. Thus, the user interface may track resource use by each application and provide information regarding the comparative use of system resources by each application

Instrumentation of the workload through the encapsulated storage file system (“ESFS”) provides a means of workload characterization. For example, when utilization levels approach threshold values in the system, the system may notify the administrator. Thus, the user interface may be configured to generate alerts based on operating parameters (block 514).

As represented by block 516, an administrator may use the user interface to reallocate system resources. The user interface may leverage and integrate the storage management tools and capabilities described herein. In particular, it may control the functional analysis applications that measure and respond to application demand and resource capacity. Thus, the system may be configured to request user input as simple as: “how much head room do you desire?” In this case, the system may specify, build and maintain the storage resource to satisfy the application, business requirements and customer objectives.

Conventional user interfaces may include a file system browser with MIME capabilities to associate plug in capability, extensible processing of file system objects based on file name extensions, such as “.html” for a WEB page. Similarly, the user interface described herein may present a file system to an administrator for organizing and managing resource allocation. Accordingly, with the use of file extensions and plug in capability, within the workflow name space, a standard WEB browser, traversing the workflow name space may be adapted to provide a user interface in accordance with this embodiment of the invention.

Workflow Name Space

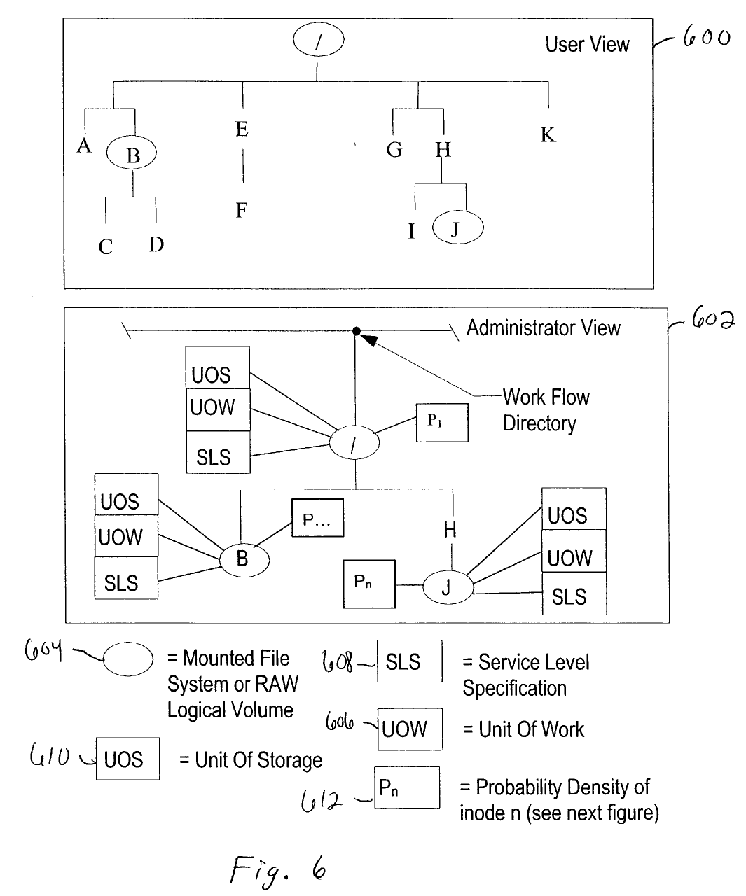

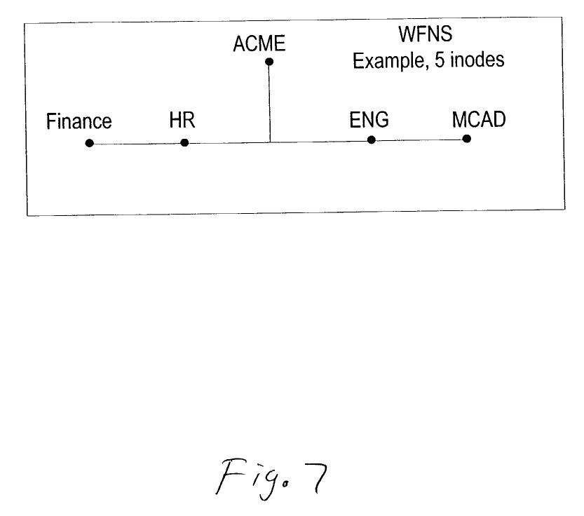

Referring now to FIGS. 6 and 7, one embodiment of a workflow name space (“WFNS”) according to the invention will be discussed. The workflow name space associates enterprise resources through the ESFS. For example, it may provide a level of abstraction between what a database calls a storage resource and what the operating environment calls the storage resource. This approach is in contrast to conventional naming conventions, where storage resource is allocated in terms of operating system, volume management, switch, network and other sub-system dependent naming conventions such as: “/devices/sbus@1f,0/SUNW,fas@e,8800000/sd@4,0:a,raw,” an example of a Solaris name for a SCSI device.

The workflow name space allows customers to allocate resources and monitor resource utilization through a naming convention that reflects the company organization, for example, along departmental boundaries. For example, the ESFS administrative WFNS provides an empirical audit trail of resource usage by business process name. Thus, a business process may be associated with an application and the I/O activity associated with that application.

By associating storage resources with the business processes that consume them, the real requirement of a business process may be better understood as it evolves through the business cycle. Thus, quantifiable improvements in the forecasting of capital investment requirements may be made thereby improving profitability by avoiding under or over purchasing of resources and by preventing resource shortages.

FIG. 6 depicts two views of a file system. The user view 600 represents the hierarchical structure typically seen by a user. This view may include logical file designations (e.g., directory C). The administrator view 602 focuses on the physical resources of the file system such as a mounted file system 604.

In one embodiment, the ESFS workflow name space is a virtual file system implemented in a network-distributed database. This embodiment is similar to NFS in that the backing store for memory occupied by an ESFS (in core) index node (POSIX Inode), the Unix VFS Vnode, is a network-based service. With NFS, a remote machine exports a file system with a set of methods for accessing the remote files, the NFS protocol. In this embodiment, however, the workflow name space is associated with methods for managing application storage resources.

The system incorporates a network-based protocol for relating applications to the physical resources (e.g., mounted file systems 604) they utilize. It associates the primary data elements, UOW 606, SLS 608, UOS 610, and probability density (Pₙ) 612, to an Inode. A WFNS name provides the primary key for the tracking of workload and resources by business process name. It ties together all the sub-systems described herein to solve the business problem of allocating optimal storage resources, and tracking resource allocation and utilization relative to the rest of a project, department, and company.

The meaning of the workflow name space directory tree, as seen by an administrator, mounting and traversing the ESFS file system, is the one created by the administrator, to their own liking and/or according to company policies. See, for example, the workflow name space of FIG. 7.

The system may provide an advantageous device name abstraction, and associated utilities, by managing the size and I/O capacity of logical devices in use by the application. Instead of the administrator building a logical volume and placing a symbolic link in a database directory for use by the RDBMS, the administrator may create the logical name directly under the path name by which it is used, as a managed resource under ESFS. Likewise the system may manage a user's file system performance by offloading hot directory sub-trees to additional supporting storage resources, transparent to the user's view and use of the file system. The system may manage the creation of in-line device files for the encapsulated file system and manage mount points in the /etc/vfstab file of the client machine using encapsulated file systems and logical volumes.

In addition, the system may specify and/or build host logical volumes from a pool of storage resources made available to the workflow name, along with file system and operating environment settings to achieve the SLS associated with the business object name.

The system also may provide an enterprise wide name service. Any location in the world where physical connectivity may be made, is a candidate to have direct access to a storage resource, and have it connected at the bandwidth required to service the remote application requesting the service. WAN and LAN capability may be supported. Administrators may authorize, authenticate, and otherwise secure the WFNS by domain. Here, the WFNS may be integrated with VPN, LDAP (nis, nis+, etc.), through the Distributed Data Services, to tie the system together under the administrative mount point of the ESFS file system.

Thus, with the workflow name space, access to storage resource by business object name may be made available anywhere in the enterprise for which there exists a physical infrastructure for the connection. This provides improved data availability, improves productivity and avoids the financial impact of down time associated with loss of availability to business applications.

Mapping Demand to Capacity

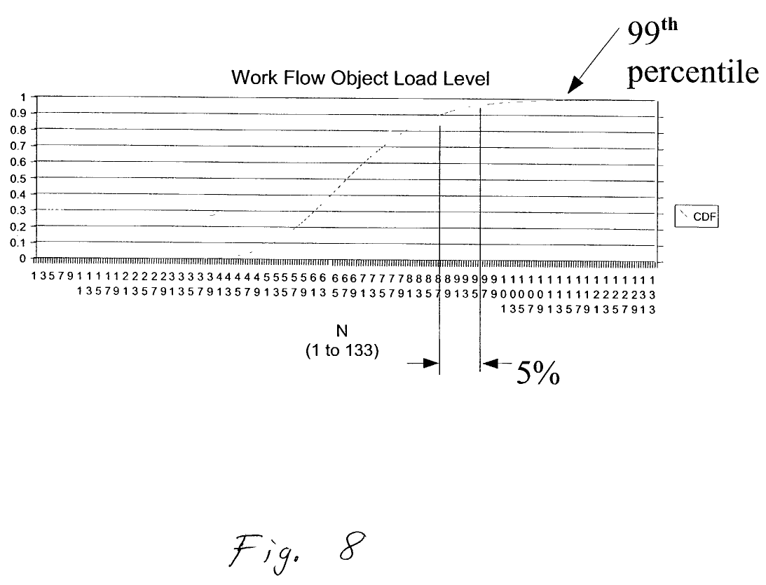

With the above overview in mind, the process of mapping application demand to storage resource capacity will be treated in more detail in conjunction with FIGS. 8-11. The following describes the relationship of I/O workload demand to storage resource I/O capacity in terms of linear operators in Hilbert space and Fourier series, with reference to Conservation of Energy. These relationships are used to determine, based on empirical data, how well a given storage resource supports an application. To this end, this process involves performing empirical measurements of system resources over a spectrum of workload operations to create physically-based models.

The concepts of Unit of Work (“UOW”), Unit of Storage (“UOS”) and Service Level Specification (“SLS”) will be used in the following discussion of the data storage management system. A brief definition of one embodiment of each concept follows.

Unit of Work

A Unit Of Work is defined as the set:

{N, I/O Size, Access Type, Range, Probability Density}

N is the load level metric. It is equal to the number of requests in queue plus the number of requests in service. N is the independent variable in this model; all response times are an implicit function of this variable. It has a probability distribution of it's own, used in the SLS to establish target performance goals. The same N probability distribution or point estimate applies to all UOW in a complex combination.

I/O Size is the number of bytes transferred in a single I/O operation.

Access Type is a unique combination of {read, write} and {sequential, random} with four possible combinations {RR, RW, SR, SW}.

Range is a measure of the I/O address range size. In one conservative embodiment this is set to the full seek range of the device.

Probability Density is a measure of the relative frequency of occurrence, the limiting probability of the UOW. It defines the contribution of each UOW based on one and the same N distribution as discussed above. There may be advantages related to exploiting probability density (normalized access density) to optimize the co-location of data on shared resources.

Unit Of Storage

A Unit Of Storage is defined as the set:

{Hardware, RAID Level, Stripe Width, Stripe Unit}

Hardware is a logical or physical storage device that, along with the characteristics and number of I/O Buses and HBAs used to connect it, defines a basis for performance expectation given the other soft configurable parameters in the UOS set.

RAID Level (soft configuration parameter) is typically 0,1 or 5, with possible combination and layering, such as 1+0 for stripped mirrors, or for instance, 0 over 5, “plaiding”, where a RAID-0 stripe at the host level is used to combine multiple RAID-5 LUNS from an underlying hardware RAID controller.

Stripe Width (soft configuration parameter) the (effective) number of data drives in the device. For a RAID-5 device, the total number of drives is effectively N+1 where N is the stripe width. In RAID-1 (or 1+0, 0+1), there are always N+N total drives, where again, N is the stripe width. This may be the single most important parameter defining the maximum I/O capacity of rotating disk media.

Stripe Unit (soft configuration parameter) is the amount of data that goes on one data drive before moving to the next data drive in a stripe. The stripe unit determines the frequency of rotation across the members of the RAID device relative to the logically contiguous addresses. It is important for defining the relationship between I/O size and number of physical disks handling a single I/O.

Service Level Specification

A Service Level Specification is defined as the set:

{Name, Percentile Range, Utilization}

Name is an ESFS workflow name, associated with a business object directory or physical resource file system and/or raw device of the ESFS workflow name space.

Percentile Range is the cumulative distribution interval for which it is asserted that the corresponding portion of the workload is less than or equal to the total probability area of the interval. For example, a value of 0.0-0.95 means that 95% of the workload, from no load level to 95% of the highest load level, will incur response time and Utilization less than or equal to the values indicated by the Utilization and Response elements of the SLS. A value of 0.90-0.95 (as illustrated in FIG. 8) indicates that the upper 5% of load level with be satisfied at less than or equal to the SLS Utilization and Response time.

Utilization is the context dependent I/O capacity of the allocated storage resource, relative to the arrival rate of requests to the workflow object. For example, for a workflow object arrival rate of 1500 IOPS, and a context dependent I/O capacity of 3000 IOPS, the Utilization is 0.5 or 50%.

Process of Mapping Demand to Capacity

To manage the I/O capacity of a storage resource (IOPS at a given response time and/or bandwidth in terms of MBits/second), the complex demand on the storage resource and the specific demand of the applications must be taken into account. From this information an estimate of the I/O capacity available to applications sharing the resource and the utilization level of the resource may be obtained.

It is important to operate a storage resource in its normal operating range, and not to saturate or over utilize the device. There is always a context sensitive limit to what any device can support in terms of throughput; however, there is no limit to the response time that may be incurred by an overloaded device. Once the saturation point of throughput is reached, response times increases proportional to load level without bound. This is the infamous “knee of the curve” which may only be determined if the precise, context sensitive, I/O capacity of the storage resource, and thus, the context sensitive utilization of that resource is determined.

The context of I/O capacity is the complex combination of I/O workload characteristics under linear transformation by the storage resource. All possible results of an I/O workload meets a storage resource may be closely approximated by a linear combination of the specific workload characteristic magnitudes, with the response time gradient of the storage resource relative to those specific workload characteristics. The following examples provide techniques for mapping capacity to demand, based on real time knowledge of the application workload and a library of storage resource performance profiles.

To make efficient and deterministic use of enterprise storage resources, not only must the connectivity issues and the myriad of naming abstractions be managed, but also, a rigorous definition of both the application I/O demand and the resource I/O capacity is required. As stated above, the I/O capacity of a given physical resource depends on the context of the complex combination of application I/O demand. For instance, 11 streams of 2 kilobyte random write is very different than 1 stream of 1 megabyte sequential read, and the combination of these two may be different than either one alone. In practice, the portion and effect of each component in a complex workload combination may be summarized and represented by marginal probability distributions and linear combinations of the components they represent. Marginal probability distributions are, by definition, the limit of relative frequencies. These limits are the portions, or “Fraction Enhanced”, in Amdahl's law, and along with Littles Law, and elementary Functional Analysis, provide a means of describing the workload in manageable units of I/O demand, and the storage resource in manageable units of I/O capacity.

For a given intersection of a UOW and UOS (notation UOW∩UOS), the methodology that follows empirically defines a response time differential dR with respect to load level N. The derivative dR/dN, is used to estimate response time for a given UOW∩UOS with N, the load level, as an independent variable. The result is weighted by the probability density of the UOW. The differential of response time is dR=m dN where m is the slope of the response time function for a given UOW∩UOS. An initial condition of response time is provided by the empirical measurement, and together with the measured derivative of response time, and probability density of the UOW, provides the analytical basis for modeling complex response time.

An arbitrary number of slopes, each representing a UOW∩UOS, weighted by access density probability, defines the complex workload response time slope, and thus, the limit of I/O capacity for the given combination, and the estimated response time for a given load level. This model is essentially a Fourier series decomposition of response time, and topologically, a closed linear manifold.

Given a complex response time slope m, the theoretical limit of I/Os per second X (IOPS) is 1/m. This limit represents the context dependent maximum capacity of the I/O subsystem for the given complex combination of workload. The expectation at a given load level, up to this limit, and the Arrival Rate of I/O into the system, as a ratio of this expectation, expresses the context dependent utilization of the UOS.

R=mN+S EQUATION 1

The relationship between N, X and R, is defined by Littles Law:

N=XR EQUATION 2

N is load level as defined for a UOW

X is throughput in I/O completions per second

R is the response time for one completion

Given a load level N, and a response time R, both functions of the UOW∩UOS, I/O capacity may be estimated as X=N/R. Utilization is defined as U=(Arrival Rate/X).

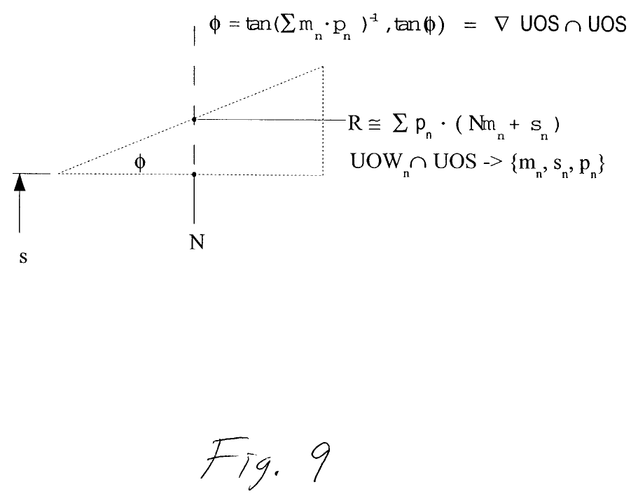

In a complex combination of n UOW with Σpₙ=1, Σpₙ·Rₙ≈R and, and the expectation of X≈N/R. In this case the probability density coefficients are applied to the individual UOWₙ∩UOS response times, and the result divided into N to define the expectation of X. FIG. 9 illustrates a mathematical model of workload response time.

Amdahls Law defines total performance differential based on the decomposition of the workload into components, and the fraction of time spent in each component. It accesses the impact a differential in performance of the component has on the whole. Intuitively, if the workload spends zero time in a component, then making that component infinitely faster has zero impact on performance, conversely, if a workload exclusively uses a particular component, then all incremental improvement in that component is reflected in the workload as a whole. The performance differential is expressed as a Speedup, as in, 2 times faster, or 5 times faster; a number greater than 1. In practice a workload is supported by various components, and spends some fraction of its total time in each. Amdahls law is:

Performance Improvement=((1-Fraction Enhanced)+(Fraction Enhanced/SpeedUP)) EQUATION 3

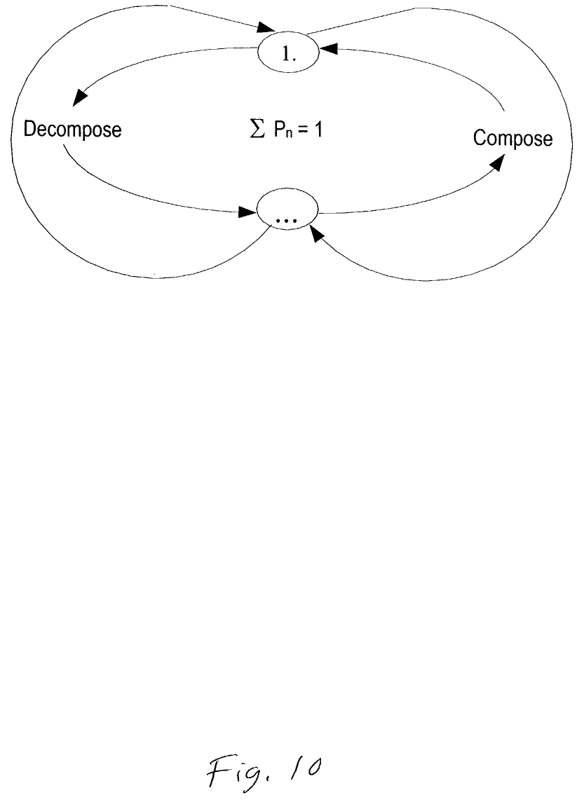

Amdahls law, can be applied recursively to any system or sub-system that can itself be partitioned into a collection of components. As represented by FIG. 10, the fractions that partition a system must always sum to 1, and all fractions are a number between 0 and 1 inclusive. These are the properties of a probability distribution, and are equivalent to the decomposition of total probability into conditional and marginal probabilities. The components of a workload so described lend themselves naturally to a probability measure space.

The above definition of UOW and UOS includes a time independent model based on the limit of relative frequency. This is consistent with the fact that I/O involves random events, which by definition, do not depend on time, only the size of a given time interval. A model of this type is referred to as a stochastic process.

The model is based on a linear operator that is a gradient in vector calculus, topologically a differential manifold, and in general, the surface integral of a vector function over a field. The system satisfies Laplace's equation and is thus a Harmonic Function in N−1 variables. The N−1 variables reflect the isomorphism between the Polynomial s of N−1 degree, and Euclidean Real space in N dimensions. A system of first order linear differential equations is isomorphic to an nth order differential equation, is isomorphic to an N−1 degree polynomial. There is a spectrum of roots, the eigen values of the characteristic function of the operator, the gradient components in this case, which correspond to the coefficients of powers of the independent variable in the exponential series, which define the general solution of an nth order linear differential equation with constant coefficients. Vector fields, linear transformations, and systems of differential equations are essentially the same. The complex response time expectation of a given UOW∩UOS may be represented as the intersection between a hyper sphere in n-dimensions (the gradient of response time for the UOW∩UOS) and a hyper plane in n-dimensions (the relative workload levels for the UOW∩UOS).

The curve thus formed corresponds to the expectation of complex response time for the UOW∩UOS. This is then used with Littles law, Amdahl's law, and subject to arbitrary n-dimensional convolution of empirical probability densities, to provide a measure space of expectation of throughput, response time, and utilization.

Stated differently, integration of the projected surface of an analytic function over a differential field on to the complex plane, with convolution of probability density provides an apparatus for defining the moments of response time for a specific UOW∩UOS, over the entire operating range of the storage sub-system. Complex response time differential corresponds to the inner product formed by two n-dimensional vectors, one component for each UOW probability density times Nfront (one for each dimension) and another vector whose components are the differential of response time with respect to load level in each dimension. The solution space is an orthogonal complement to the sub-space of relative workload levels. This is a proper Hilbert Space, it is an example of a complex trigonometric Fourier series.

There is one dimension for each UOW∩UOS of the workload in the fundamental system of equations representing expectation of complex response time for the storage resource allocated to the given application workload.

In the model, response time is a vector orthogonal to the linear manifold defined by a system of UOW∩UOS vectors. A system of load level vectors is transformated by the differential linear operator, in real time, consisting of a matrix with the UOW∩UOS gradient vector on the diagonal and zeros elsewhere and weighted by the UOW probabilities. The result value of the integral so obtained is the mathematical expectation of response time for a complex UOW∩UOS combination. Empirical boundary conditions are weighted by probability density of the UOW to define the constants of integration, one for each dimension.

These dynamically generated functions are used to predict the behavior of a complex physical system: The storage sub-system. The model provides for dynamic adjustment of the real time expectation based on updated profiles of the storage resource through subscription library services and dynamic update of relative workload levels, composition and utilization, through the facility of ESFS.

### EXAMPLE

Application of the above operations will be further explained by way of an example. This example describes a workload model for response time expectation of a complex I/O workload applied to a given storage subsystem resource, and the inverse problem of determining the amount of the given storage resource required to satisfy the given workload at a predetermined response time. The first part of the model demonstrates UOW∩UOS≈SLS. The second part demonstrates UOW∩SLS≈UOS.

The mathematical expectation of workload response time was discussed above in conjunction with FIG. 9. This discussion treated the model as an example of linear operators in Hilbert space. Hilbert space is an n-dimensional Euclidean space, a metric space equipped with an inner product. An inner product is the cosine of the angle between two vectors in n-dimensional space multiplied by the absolute values of each of the two vector magnitudes (norms); it defines at any given point along one vector, the orthogonal distance to the other vector. A metric is a distance. Conceptually, and mathematically, in the model, response time is the distance between the workload and the storage resource in Hilbert space. Response time is a sub-space of Hilbert space, which is orthogonal to the UOW∩UOS linear manifold of probability and load level. The response time state vector is the Pythagorean theorem (A²+B²=C²) generalized to n-dimensions. The cosine is the base; the sine is the rise of a triangle. The state vector of complex response projects onto each UOW axis a directional cosine, and associated with a cosine, is a sine. Each sine is the perpendicular distance (the shortest distance) between a UOW axis and the response time state vector. The differential of response time is the inner product between the weighted load level vector, and the storage resources differential operator of response time (a gradient vector) with a matching component for each component of the workload. They share the same dimensions, which is an isomorphism between them. Response time is approximated by the weighted sum of these sines, as defined by empirical data; the measured differential of response time with respect to load level with initial conditions for each fundamental UOW∩UOS. An arbitrary complex workload is thus represented by a linear combination, or superposition of a fundamental UOW∩UOS basis. The model is n-dimensional because it deals with functions of a single independent variable of which there are an infinite number. These functions define the mapping between a workload and a storage resource. Important functions are treated foremost, as defined by cumulative probability distribution, and as required to meet the desired level of precision in the approximation. The example of Hilbert space is called L², a square integralable space of continuous functions of bounded variation. Lebesgue measure of Sigma Fields and Borel Sets are the probability distributions. Linear operators of proportion modeled as probabilities, define the workload in this way. The probabilities are applied to first order harmonic linear differentials and initial conditions of response time, a Fourier series. Upon integration, response time is approximated by a single linear equation of the form R=Nm+s, in 2-dimensions: R and N. This single function results from the converging series of differentials, initial conditions and probabilities. The model is a particular example, and pragmatic application, of the above completely general concepts and topics of functional analysis, distribution theory, and mathematical physics.

There are three types of probability distributions in the model. The spectral analysis of a UOW defines a single UOW variable in n-dimensions, corresponding to one row in a UOW stochastic matrix (the rows sum to 1). The definition is analogous to a point in n-dimensional space with the restriction that the sum of coordinates for any one point is 1. The second type of probability distribution associates UoW points into scalar rings, which again sum to 1. Each row in a UOW probability matrix has an associated ring probability. The first type of probability distribution is a function of an application workload, the second kind, a function of the WFNS, and Amdahls law, applied to all applications in the WFNS, conserving energy and probability. When the ring probability is applied to the UOW probability, the result is a probability distribution, a matrix where the sum of all elements is 1. These are used to scale load level, in n-dimensions, in the approximation of response time. The third probability type is one or more probability distributions for various workload parameters of interest; first and most importantly, load level. Others of this type may include, for example, arrival rate and the number of concurrently active devices. Load level is the single independent variable of the model. Arrival rate is used to establish utilization.

The following examples are based on an example storage resource for which the differential of response time with respect to load level, and initial condition of response time, for a set of four fundamental UOW∩UOS combinations is defined. In practice, these metrics will come from the Storage Resource Profiler (SRP) component facility discussed below.

TABLE 1

| UOW∩UOS | | |
|---|---|---|
| n = {1, 2, 3, 4} | ∂R/∂N = mₙ | IC = sₙ |
| 1 | .0025 | .003 |
| 2 | .0035 | .004 |
| 3 | .0045 | .005 |
| 4 | .0055 | .006 |

Table 1 defines the fundamental basis for the examples that follow.

A complex workload is defined as a set of probabilities applied to each of the above, which represent for instance 8 KB RR, RW, SR, SW, for a given UOS hardware resource.

The above metrics may be obtained from measurement of the storage resource hardware. They need not depend on any workload. Hence, they may be an intrinsic feature of, and characterize the hardware.

A workload (e.g., an I/O workload) is defined by a set of limiting probabilities with regards to a given basis (as defined in the above table) and a load level probability distribution.

Load level in the model is defined as the number of I/O requests in the system, both in service and in queue, and an associated probability distribution.

The aggregate load level, across all devices of an application is called Nfront. This is in contrast to Ndd, or load level per data drive (which can be generalized to a storage resource unit), Ndd=Nfront/UOS−>stripe_width.

In practice, Nfront generally has a Poisson distribution, as the probability of a given load level depends on the current load level, and is a random variable. Nfront is independent of time. The Poisson distribution depends on a single parameter, the average.

A point estimate of the average IOPS expected at the average Nfront load level is a satisfactory basis for a capacity-planning estimate and is sufficient for demonstrating the model. The response time at various other load levels also may be approximated by the model, and weighted by the Poisson probability for the Nfront load level estimated. An example of integration over an interval of load level also will be discussed. Implementation facilities also provide an empirical probability distribution for Nfront. However, as it has been observed to deviate little from the Poisson distribution, the latter is generally sufficient, as are point estimates for the average, and the 99^{th} percentile, for instance, as specified by the SLS.

The examples that follow demonstrate the matrix operations of the model. Two matrices called mm01 for the differential of response times, and ms01 for the corresponding initial conditions of response time, as defined in table 1, are used throughout the examples:

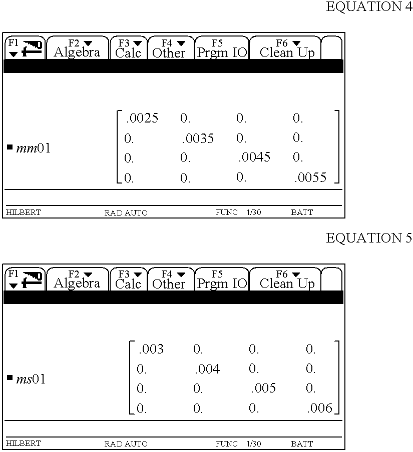

The two basis matrices are intrinsic to the storage hardware they represent. Once a load level and a probability distribution is applied to the above matrices an expectation for response time for a given UOW∩UOS may be calculated.

The first probability distribution is a vector called p01. It is a single variable in four dimensions corresponding to the four dimensions of the basis, as defined by and corresponding to table 1. The sum of elements of the p01 vector is 1, which is a property of a probability distribution:

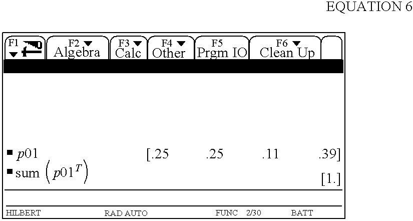

Multiplying Nfront with the differential linear operator defined by the matrix mm01 and adding the initial condition matrix ms01 to the result yields an estimate of response time for each component of the UOW:

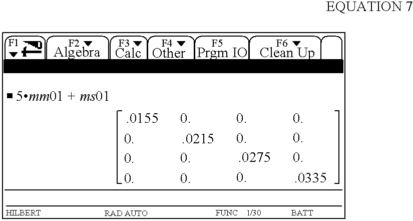

The above is the estimated response time for each of the workload components at the specified load level of 5 in this example.

Scaling individual response times by the probability distribution, p01, and summing the result, the expectation of response time for the combination, 25 ms is obtained:

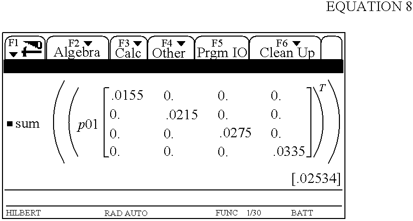

Applying Littles Law, X=N/R, provides an estimate of I/O capacity for this load level and workload composition, 197 IOPS:

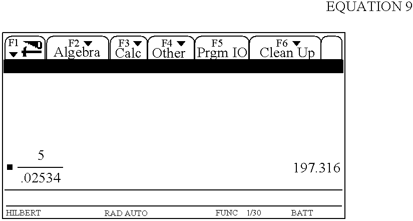

The above is an estimate of I/O capacity at 100% utilization. The application arrival rate is used to estimate utilization as the ratio of I/O capacity available. For instance, if the application average arrival rate is 80 IOPS, then the utilization is 80/197˜41%.

The above example shows the basic model for response time estimates of a complex I/O workload.

A more complex example involves merging six workloads onto a single storage resource. The matrix mp06 represents six individual probabilities, the first of which is the vector p01 used in the previous example:

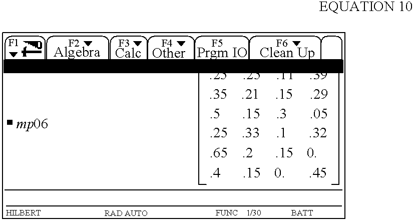

This matrix, mp06, is not a proper probability distribution, because it does not sum to 1. It is a row stochastic matrix as each row sums to 1:

There are two equivalent ways to proceed, each having application to different ways of partitioning the workload. The first method corresponds to the grouping of workload units (UOW) in to sub groups and treating each sub group as a single unit. The second method corresponds to combining all the UOW into a single unit.

1) A new probability distribution called mp08 is used to scale the differential and initial condition matrices, mm01 and ms01, thereby defining new differential and initial condition matrices, mm02 and ms02. The new basis includes the combined probability distributions of the six UOW defined in mp06.

2) The new probability distribution mp08 is used directly, as in the first example, using the original mm01 and ms01 basis matrices.

In both cases a 6-dimmensional-probability matrix, mp07, the ring probability, defines the probability distribution of the six UOW to be combined from mp06. The mp06 row stochastic matrix is transformed into a proper probability distribution by operation of the mp07 matrix. The result is the new UOW probability distribution called mp08.

The matrix mp07 is the ring probability distribution that is used to scale the six UOW defined in mp06 against the 4-dimmension basis as defined in table 1. It is in fundamental form, eigenvalues along the diagonal, to be used as an operator:

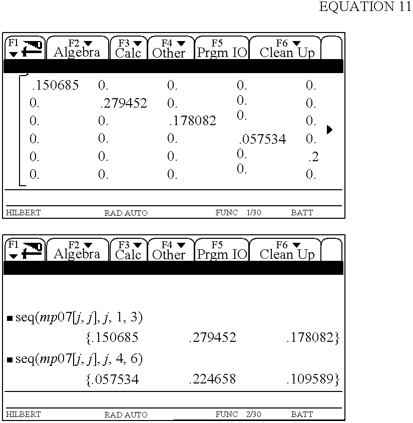

Each row of the matrix mp06 represents a UOW probability distribution. Associated with each UOW is an average Nfront. The ring probability distribution of a combination of UOW is defined as the relative magnitude of each Nfront to the sum of Nfront values. Two different examples in 4 dimensions follow:

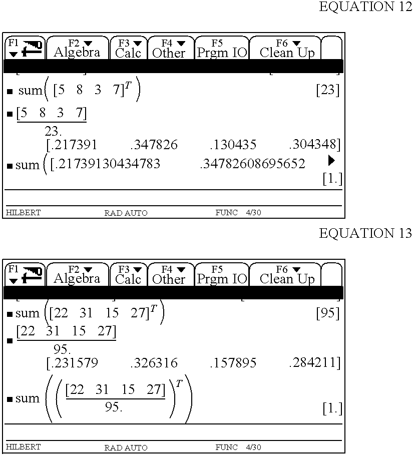

Continuing with the example, the six UOW, row stochastic matrix mp06, is multiplied by the corresponding ring probability, mp07, to produce a new UOW probability distribution, mp08, defining the relative portions of the six UOW. These proportions are with regards to the original differential and initial conditions of response time, mm01, and ms01, as defined in table 1. The mm01 and ms01 basis define the 4-dimmensional space of which the six UOW of mp06 are points:

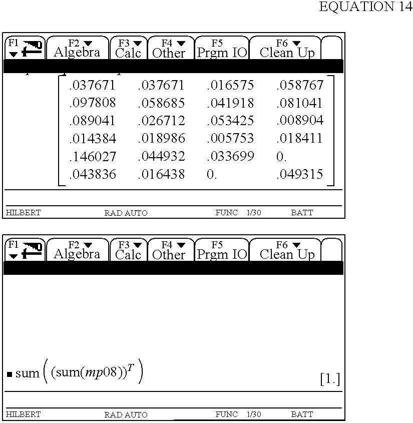

The second method simply applies the new probability distribution, mp08, to the original basis mm01 and ms01 as defined in table 1:

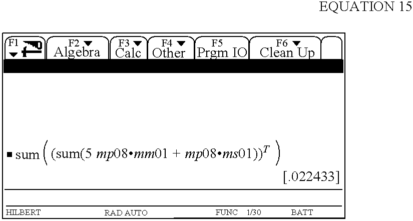

The second part of the example solves for the stripe width element of a UOS to achieve a predetermined response time according to a given SLS. A library of UOW∩UOS, differentials and initial conditions, is searched to locate the minimum differential and initial conditions. A smaller value implies a solution requiring less physical resources then a solution with a larger value. For the current example it is assumed that the basis defined in table 1 is the best fit.

Using the above defined basis in table 1, and the UOW and associated probability distributions developed in the previous examples, UOS requirements to satisfy the UOW at a given response time are presented.

The model solves for the utilization level specified by the SLS by determining first the required response time to satisfy the SLS, and then the UOS stripe width required to satisfy the response time.

One of the elements associated with the WFNS is the arrival_rate distribution (and moments: average, standard deviation . . . ) of I/O to the named workflow object.

One of the elements of the SLS is a utilization factor.

One of the elements of the UOW is Nfront.

To solve for the stripe width of the SLS, for a given candidate basis UOS, the process first determines the target response time at the specified utilization.

R_{target}=[Nfront/arrival_rate]·utilization EQUATION 16

Proceeding with the example, defining a utilization factor of 50% (0.50), Nfront of 5, and arrival_rate 1200:

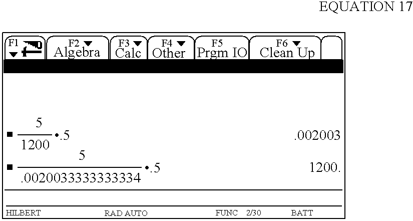

R_{target}=0.002083

The model solves for R_{target} by reducing the system to a single linear equation representing the state vector of response time. The n-dimensional system of UOW and associated probability distributions converge to:

R=mN+s EQUATION 18

Solving for N yields:

N=(R−s)/m EQUATION 19

The convergence is carried out separately for the differential and initial condition matrices by taking the row marginal distribution of the simple or complex UOW matrices.

Returning to the UOW definitions of the first example:

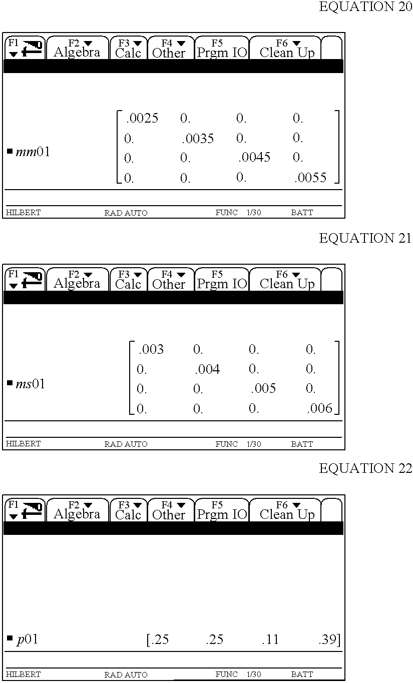

The total differential of response time, m, and initial condition, s, of this system:

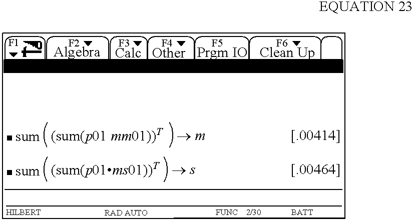

Applying the model to solve [Ndd=(R−s)/m] yields (R=R_{target}=rt):

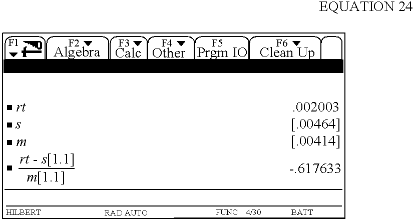

The answer is in the negative indicating that the system has no solution. This condition can be recognized at once by noting that the target response time, called rt in the calculation, is already lower than the initial condition of response time for the system. The initial condition of the state vector of response time, as represented by the convergent series above, is the smallest response time possible for the given UOW∩UOS.

For the model UOW∩SLS≈UOS to have a solution, the target response time obtained by the constraints of the SLS must be greater than or equal to the convergent series of initial conditions matrix defined by the UOW∩UOS.

To resolve this issue: 1) the constraints on the system with regards to the utilization requested by the SLS may be relaxed, and/or 2) Nfront increased by tuning the application, and/or 3) seek faster hardware, and/or 4) if the UOW is a complex combination of UOW (a matrix with more than just the eigenvalues on the diagonal), separate the UOW into components and determine if each is solvable on its own, repeating the above process for each of the UOW.

The requisite low response time in this example is driven by the low utilization requirement of 50%, and a rather low load level of 5, and a rather high arrival_rate of 1200.

Continuing the example to explore options to resolve the system:

Relaxing Utilization:

R_{target}=[Nfront/arrival_rate]·utilization EQUATION 25

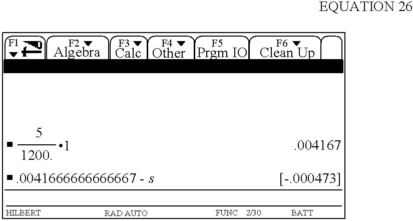

At 100% utilization the system has a solution, (s is larger than R_{target}). However, it may not be desirable to configure the system for 100% utilization. Some amount of headroom may be necessary.

Increasing Nfront:

Returning to the original requirement of 50% utilization, solving for Nfront, given the model for R_{target}.

The goal is to find the minimum Nfront for which the system is solvable. This is determined by the convergent series of the initial condition matrix, s, in the current example:

Nfront=[arrival_rate·s]/utilization, s=R_{target} EQUATION 27

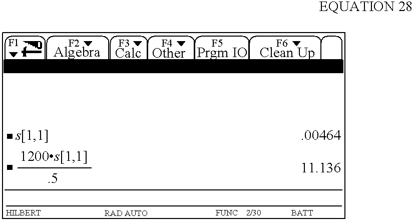

At Nfront 11.136 the system is solvable:

R_{target}=[Nfront/arrival_rate]·utilization EQUATION 29

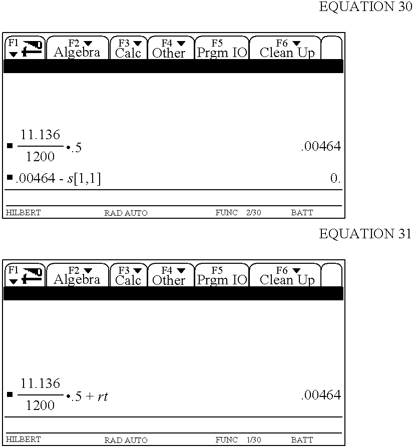

R_{target}=0.00464

Assuming the application may be tuned for higher concurrency, so that the same arrival rate is demanded from an average of 12 streams rather than 5, the process returns to the example to solve for R_{target} at the new load level. The system will incur a point of singularity if the exact root above is used. It is necessary to round up to 12 in order to avoid the singularity and assure that R is less then or equal to R_{target}:

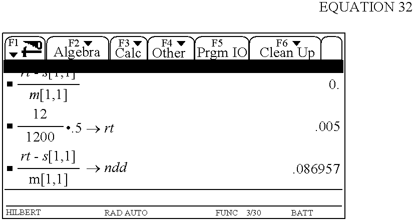

R_{target}=0.005

[Ndd=(R−s)/m]=0.86957, R=R_{target}=rt EQUATION 33

The required UOS−>stripe_width is:

[Nfront/Ndd] EQUATION 34

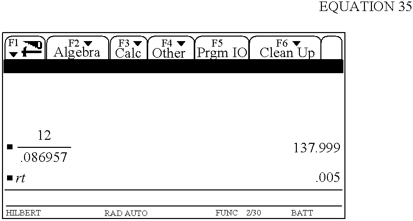

It has been determined that, for the UOW∩SLS under consideration, with an Nfront of 12; 138 units of the specified UOS may meet the response time target of 0.005.

The same process of solving for Ndd, based on the convergent series of differential and initial condition matrices, and the formula provided, work in a similar manner with compound UOW matrices (one row for each UOW with a correspond probability ring) as discussed above.

An example integration of Littles Law with the model of response time both in mean value and utilizing a Poisson probability distribution of Nfront is now presented. As mentioned previously, point estimates of the average and upper percentile are generally sufficient in practical application of the model. Integration may however, especially with an empirical probability distribution of Nfront, define precisely the mathematical expectation of throughput.

The antiderivitive of Littles Law, X=N/R, with the model for response time R=Nm+s over a load level interval from a to b:

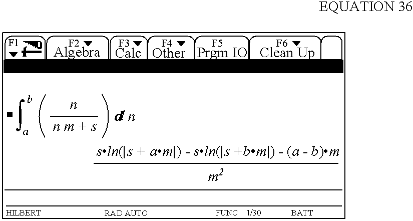

Proceeding, as in the previous example, by defining the state vector of response time as a convergent series of differentials, initial conditions and probabilities:

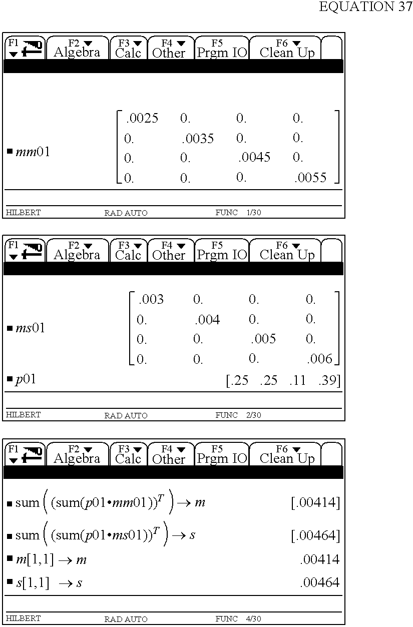

The area under the throughput curve, representing the number of I/O completed in one unit of time (second) at each load level from, a=1 to b=9, and mean value:

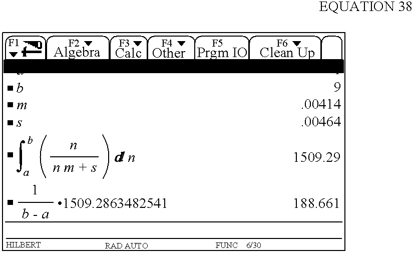

Mean value=189 IOPS. The average load level is 5:

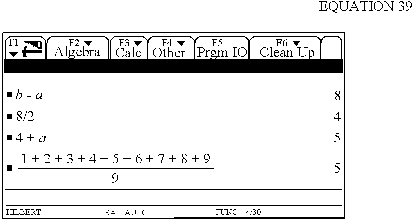

The point estimate for the average:

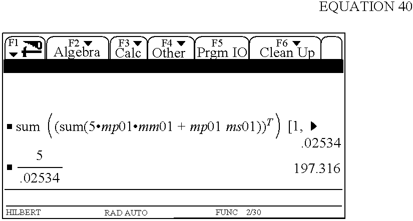

The point estimate agrees to within 4% of the integration mean value. Applying the Poisson distribution to each Nfront load level:

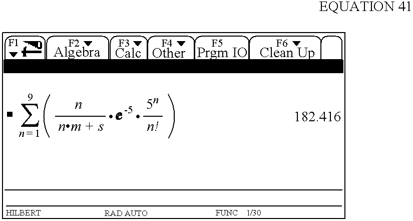

The expectation is 182 IOPS and is within 4% of the integration mean value, and within 8% of the point estimate.

System Components

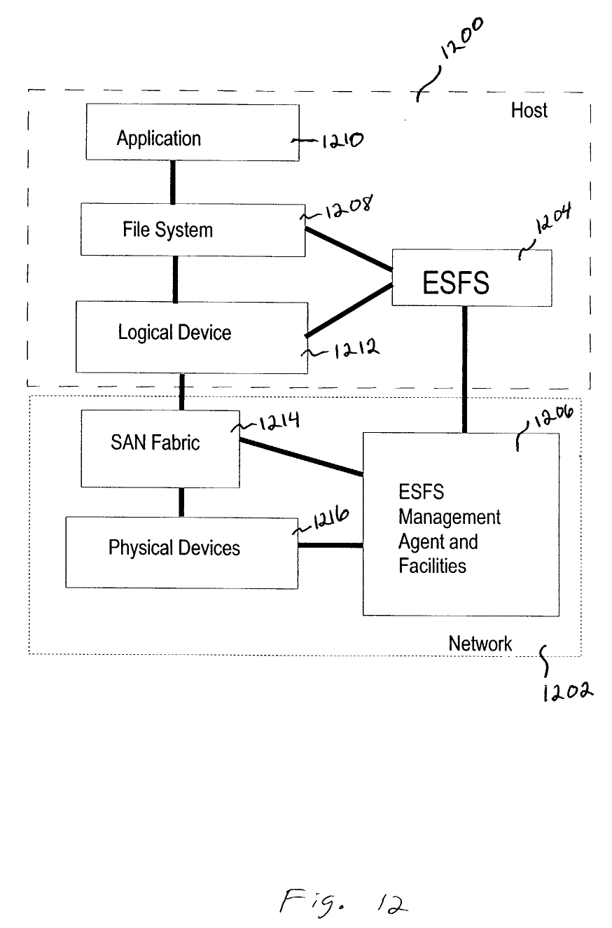

Referring now to FIGS. 12-20, various embodiments of operational components of data storage management systems constructed according to the invention will be discussed. In general, these operational components may be implemented in hardware and/or software. Significant blocks are treated separately in the discussion for each figure including a description of the operation of the components and the interactions of the component with other components in FIGS. 12-20.

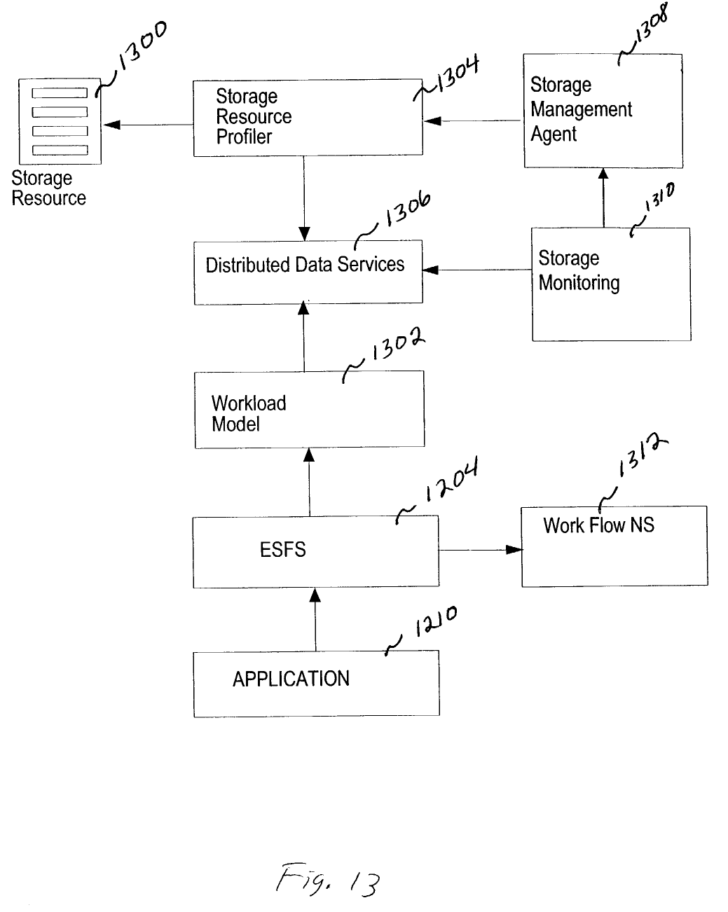

FIG. 12 is a block diagram of one embodiment of a computing system constructed according to the invention. The computing system includes data storage management system components that provide automated storage configuration, replication and connectivity. To this end, the data storage management system tracks workflow to determine storage resource allocation and utilization as discussed in conjunction with FIGS. 13-30.

In FIG. 12, a host processor 1200 communicates with networked data storage resources 1202. In accordance with one embodiment of the invention, the system includes encapsulated storage file system components 1204 and 1206 as described herein. Thus, the ESFS 1204 cooperates with a file system 1208 to provide an encapsulation layer to monitor I/O activity between an application 1210 and a logical device 1212. In addition, the EFSF management agent and facilities 1206 manages the SAN fabric 1214 and the physical devices 1216 in the networked data storage resource 1202 to allocate resources to meet performance objectives.

ESFS (“FSE”) 1204

This component is an administrative interface for SLS, application instrumentation, and logical address space mapping control. It depends on WNS, WLM and IOS and serves the Application 1210. Inputs are 1) Existing File System and/or raw device, 2) ESFS workflow directory name. The output of the component is File System or Device Encapsulated.

ESFS provides an administrative name space, specifically, the ESFS Workflow Name Space as an abstraction layer for the allocation and monitoring of storage resources, for both new and existing file systems and raw logical volumes contained in an encapsulated file system. Additionally, it implements workload instrumentation for use by the Analysis Prediction and Solution facility. The directories in this file system are WFNS names, being driven off the network DDS facility. The files, in this file system, shadow the encapsulated logical resources associated with a real file system and/or raw logical volumes, in the real file system.

The address space mapping between the logical and physical devices may be dynamically updated to optimize I/O performance. I/O scheduling may include I/O priority, and optimal layout based on complementary time domain access probability.

Associated with a WFNS name is, an application, a UOW analysis of I/O of devices in use by the application, an SLS for the supporting UOS, a history of UOW and performance results, and a probability density for the application relative to the rest of the encapsulated resources in the WFNS.

An administrator requests a storage allocation for a workflow name, and the system will specify the storage configuration to meet the allocation within the SLS, based on the current pool of resources. When the SLS can no longer be satisfied with the storage pool authorized for the workflow directory, the administrator will be notified to allocate additional resources to the workflow name.

FIG. 13 depicts operational components relating to acquiring empirical data (e.g., a workload model and a profile of a data storage resource 1300) and associating the empirical data with a workflow name space.

Workload Modeling (“WLM”) 1302

This component provides workload context definition for an application and/or address range. It depends on DDS and serves FSE. Inputs are 1) UOW events as measured in real time by ESFS, and 2) Workflow NS name [address,size]. The output of the component is the Unit of Work definition saved to the DDS facility and associated with the WFNS name.

A UOW is defined for each encapsulated resource associated with an ESFS workflow directory name. It describes the workload and performance of a set of logical and physical resources associated with an application through the WFNS name. Historical audit trails of the UOW per workflow name are maintained for workflow analysis in the DDS. For instance, time series analysis is provided to identify trend T, seasonal component S, cyclic component C, and irregular variation V, of the named workflow object.

Data structures defined by this facility are used by the Performance Analysis Prediction and Solution facility through the Distributed Data Services facility. The UOW are partitioned by elements of the UOW: I/O size, address range, probability distribution for Nfront, and a Bernoulli Distribution with regards to Access Type (rr, rw, sr, sw); a 1, in a given bit position indicates an instance of the associated workload characteristic. The result collection of bit strings and relative frequency of 1s is a measure of joint probability. The result is a measure space of the joint probability of workload characteristics.

Marginal limiting probabilities are obtained by relative frequency summation of Access Type bit fields, per I/O size and range, and weighted by the Probability Density for each UOW by the Analysis, Prediction and Solution facility to establish expected performance for a UOW∩UOS.

Storage Resource Profiling (“SRP”) 1304

This component provides analytical bases for response time estimates. It depends on DDS and serves SMA. Inputs are 1) Profile Request Descriptor, and 2) Storage Descriptor. The output of the component is Point Slope intercept of response time differential with respect to load level for each UOW∩UOS combination requested, full spectral analysis by default.

The component provides the key analytical data, and empirical basis, for complex response time expectation for a UOW∩UOS combination as discussed above. The components returns the slope of response time differential with respect to load level and initial condition (single threaded access) for a specific UOW as applied to a specific UOS.

These data are collectively, a point slope linear equation for each pure, fundamental UOW∩UOS combination, and are obtained from direct measurement of the storage resource as directed/requested by the Storage Management Agent.

This profiling is destructive to the data in the storage media, and may require an initial non-recurring dedicated resource for the measurement. As new resources, or new configuration options are added to a storage pool, new measurements may be needed to provide the best model results.

Distributed Data Services (“DDS”) 1306

This component provides a network wide information database. It depends on LDAP and serves WNS, WLM, SRP, SPM, SAC, APS, SMA, UPM, AMS, SLV, CPA and CAA. Inputs include UOW, SLS, UOS and ESFS Workflow NS. The output of the component includes UOW, SLS, UOS and ESFS Workflow NS.

This component provides general purpose distributed data services. It provide the ESFS name space abstraction and relates application demand and resource capacity to workflow name space objects.

Storage Management Agent (“SMA”) 1308

This component is a general facility to implement actions and services. It depends on SRP, LDC, FSC, OSC, SAC, APS, DDS, SRA, RPS, PDC, CPA and CAA and serves WNS, UPM and SPM. Inputs are Request for actions. The output of the component is Actions Implemented.

This component is the command and control hub of distributed services over private VPN network, and the primary facilitator of product functionality. This is an inetd (1M) based service responding to requests on registered network ports. All user interface code, GUI or otherwise, may be implemented by calls to the SMA via network based protocol via the UNIX inetd facility. In one embodiment no functionality, other than interaction with the user, is implemented in the user interface layer. The SMA handles all requests by the user interface, and/or other client components.

Storage Performance Monitoring (“SPM”) 1310

This component is a facility to provide real-time feed back on accuracy of predictions and expectations and to provide threshold alerts for SLS requirement boundary conditions. It depends on SMA and DDS. Inputs are Expected vs. Realized performance data from the DDS. The output of the component is Alerts and/or Event generation for corrective action.

This facility is a sub-set of Utilization and Performance Management. It reports/records the standard error distribution of expected vs. realized for the SLS relative to the UOS associated with a WFNS name. If prediction levels are not satisfactory, a higher resolution analysis with updated sample of workload and or storage resource may be requested. Threshold events of performance relative to the SLS are reported/recorded and may generate requests for action.

Event driven actions includes reconfiguring the I/O address space of the application non-disruptively, and dynamically.

Workflow Name Space (“WNS”) 1312

This component provides a means of associating application workload and resource usage by customer defined business application and/or process names, presented as a file system tree, whose leaf nodes shadow the managed resources of real file systems and or raw devices. It depends on DDS and serves FSE. Inputs are 1) ESFS workflow directory name, and 2) File systems and/if raw devices to be encapsulated and managed. The output of the component provides a virtual file system directory tree associating business applications with performance specifications, resource allocation and utilization data.

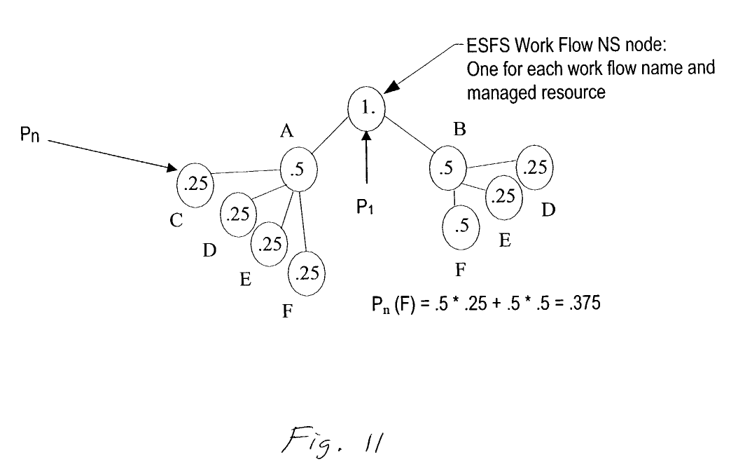

Encapsulated file systems and/or raw devices are associated with the ESFS workflow Name Space. The system maintains a normalized view of application demand, resource capacity and utilization across the name space. For example, 100% of the resource and 100% of the demand are associated with the root level of name space tree, representing the sum total of encapsulated resources for a company. At this level the system will provide an overall description of the company workload and utilization. As the name space tree is divided into department, cost pools, and other business process names, the workflow name space maintains relative demand, capacity and utilization for the department, cost pool and business process. See, for example, the probability distributions in FIG. 11. This process continues down to the leaf nodes in the tree where specific storage resources, for specific applications for specific department, cost pool, or business processes are located.

With context sensitive logical address space, the tree drills down yet further to identify address ranges within a single application device. The workflow name space is accessed through the administrative mount point of ESFS, and spans a companies operation network wide.

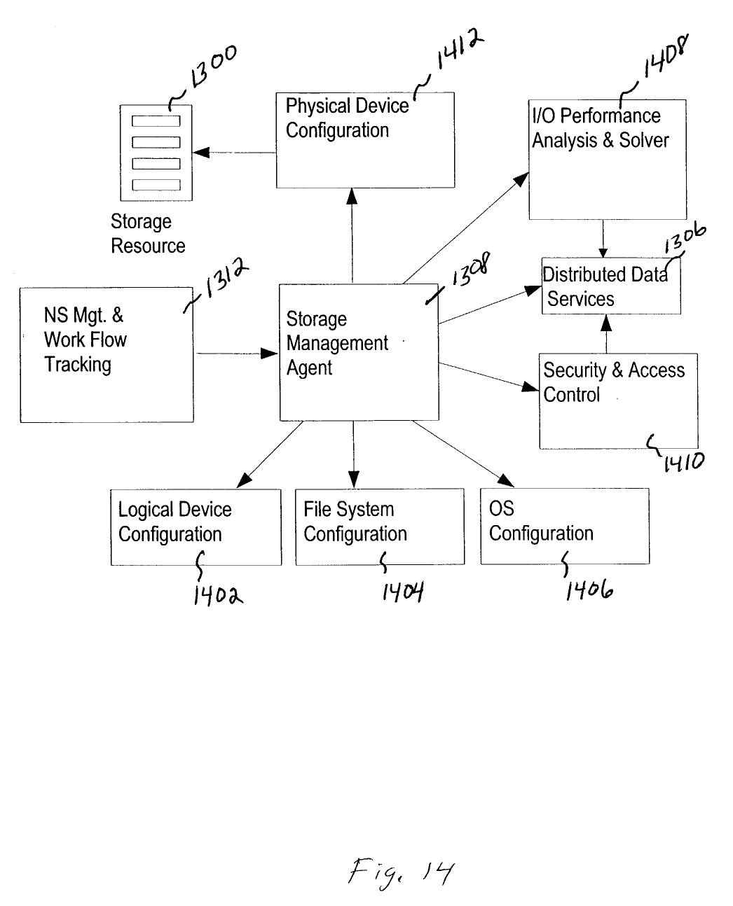

FIG. 14 depicts operational components relating to the control of system operation by a storage management agent.

Logical Device Configuration (“LDC”) 1402

This component provides facilities to create logical devices from physical resources according to context sensitive storage configuration design specifications derived by the APS, and requested by the SMA. It depends on Logical Volume Management Product and serves SMA. Inputs are 1) Storage Descriptor, and 2) UOS Specification.

Logical devices are configured to directly satisfy an application file system or raw device I/O requirement for an application. They are the UOS objects of I/O capacity and storage space allocation designed to satisfy the SLS associated with the workflow name space application. This component provides a level of abstraction for converting the specification of a UOS to the required commands to create an operating system logical device to satisfy the SLS. This may be implemented using as VxVM, or SDS, by the generation of batch command line scripts, or other API.

File System Configuration (“FSC”) 1404

This component provides facilities to build or tune a file system. It depends on File System Product and serves SMA. Inputs are 1) UOW∩UOS, and 2) Logical Device on which to build a file system or Logical Device containing a file system to tune.

This component provides a level of abstraction for converting the specification of a UOW∩UOS to the required commands to create or tune a file system to satisfy the SLS. This will generally be implemented using UFS, QFS or VXFS, by the generation of batch command line scripts, or other API.

OS I/O Configuration (“OSC”) 1406

This component provides facilities to adjust kernel I/O parameters based on context of UOW. It depends on the Operating System and serves SMA. Inputs are 1) UOW, and 2) Host.

This component provides a level of abstraction for converting the specification of a UOW∩UOS to the required commands to tune the operating system I/O path to satisfy the SLS. This will generally be implemented using Solaris by the generation of batch command line scripts, or other API.

This component may include an API level interface for kernel I/O variable management.

I/O Performance Analysis, Prediction & Solution (“APS”) 1408

This component is a facility to apply Spectral Analysis and Linear Transformation of a workload's component proportions by a storage resource's response time differentials with application of Littles' Law and Amdahl's Law to determine an optimal solution for a given UOW∩SLS requirement or to provide an estimate of a given UOW∩UOS. It depends on DDS and LSS and serves SMA and IOS. Inputs are 1) UOW and SLS, or 2) UOW and UOS. The output of the component is 1) UOS specification for satisfying the UOW at the SLS, 2) Expected Throughput, Response Time and Utilization for the UOW∩UOS.

This module applies the analytical model to make a prediction for a “what if” analysis, or to solve a system of equations representing the constraints of the SLS, the demand of the UOW and the available storage resources.

Security and Access Control (“SAC”) 1410

This component checks credentials of user and workflow name authorizations with regard to the requested operations. It depends on the Operating System, Database, Framework and LDAP and serves SMA. Inputs are 1) ESFS Workflow name, and 2) Type of access desired. The output of the component is Status.

This component provides a level of abstraction for authorization of operations based on authentication of the requester. This may be implemented using standard network login protocols and LDAP password and group files, and other security extensions as needed.

Physical Device Configuration (“PDC”) 1412

This component is a facility to define RAID devices or other logical storage resource in a device dependent manner. It depends on Storage resource APIs and serves SMA. Inputs are UOS. The output of the component is a device configured to UOS specification.

Provides a level of abstraction for the device dependent configuration of physical storage resources.

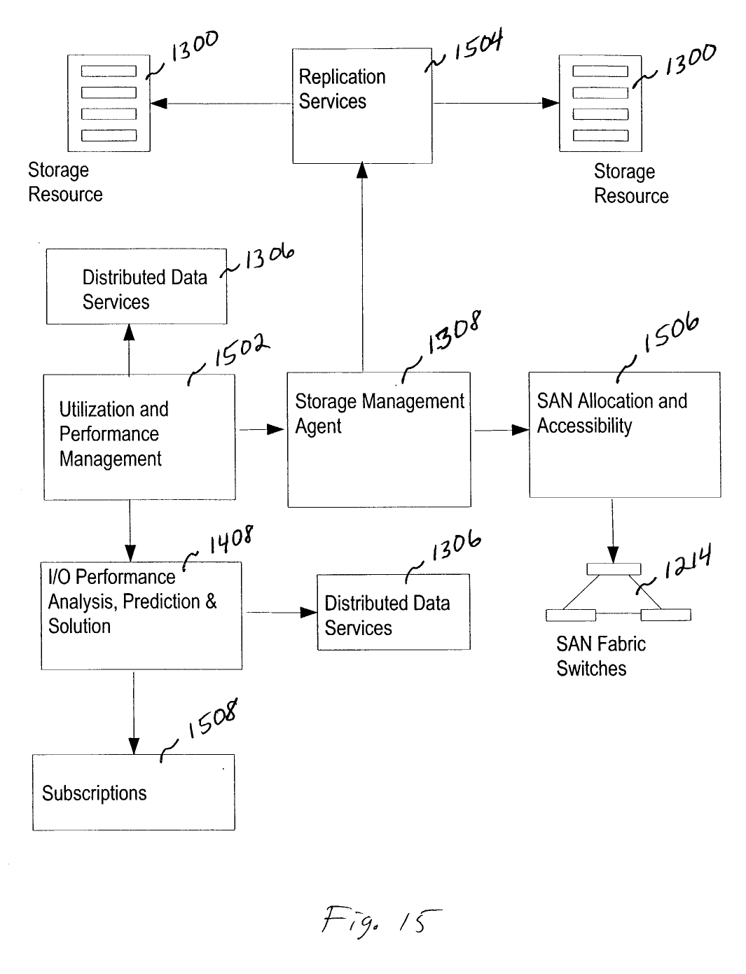

FIG. 15 depicts operational components relating to a utilization and performance manager that may automatically invoke reconfiguration operations.

Utilization and Performance Management (“UPM”) 1502

This component provides utilization assessment and provides preemptive action and/or alerts for utilization levels over SLS thresholds. It depends on SMA, APS and DDS. Inputs are ESFS Workflow NS objects. The outputs of the component are Alerts and/or reconfiguration events.

Monitors the real-time performance and utilization of the system resources. Compares expectation to actual. Validates prediction accuracy and calculates prediction error margins. Invokes corrective action to assure SLS for each UOW. Utilization is based on context sensitive assessment of the UOW∩UOS.

Replication Services (“RPS”) 1504

This component copies data from source to destination for replication and/or re-layout of logical to physical address space mapping. It depends on Operating Environment and/or 3rd party utilities for replication services and serves SMA. Inputs are 1) Source logical device, and 2) Destination logical device.

This component provides a level of abstraction for point in time copy. RPS may be invoked in response to context sensitive address space optimization, or utilization threshold events.

SAN Allocation and Accessibility (SRA”) 1506

This component is a facility for allocating storage resource and connectivity bandwidth over the SAN. It depends on SAN fabric and storage resource APIs and serves SMA. Inputs are UOS specification for provisioning. The output of the component is WWNs of resource allocation set.

This component provides a level of abstraction for SAN fabric resource allocation.

Library Subscription Services (“LSS”) 1508

This component provides subscription services for library of UOW and UOS models from an Internet based central repository. It depends on Published UOW and UOS library data and serves APS. Inputs are 1) UOS, 2) UOW of interest, and 3) Workflow class names. The output of the component is Storage profile library data.

When specifying new storage resource for a new application, or when seeking optimal storage resource for a growing application, this component provides workload models and storage resource profiles for workloads and/or storage resources not in the current environment.

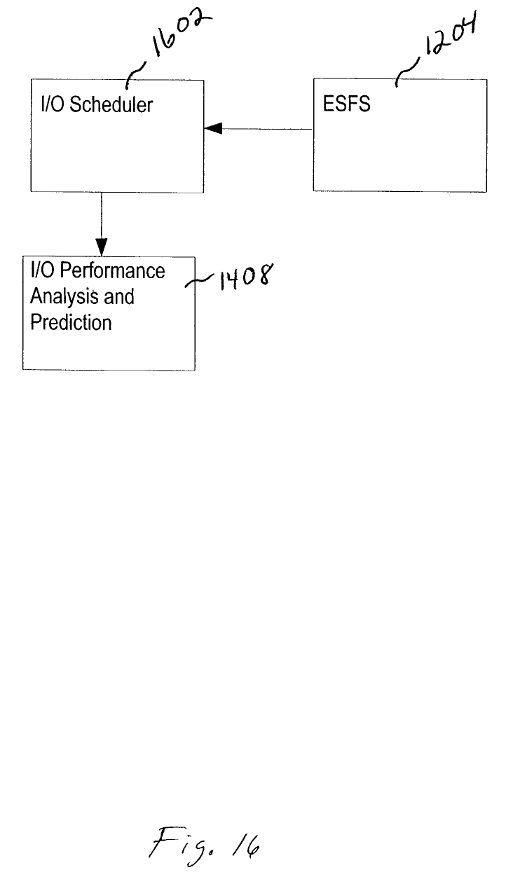

FIG. 16 depicts operational components relating to I/O scheduling.

I/O Scheduler for Optimization and Priority (“IOS”) 1602

This component implements I/O dispatch algorithms based on priorities and complementary time domain access distributions of workflow objects. It depends on APS and serves FSE. Inputs are ESFS Workflow NS objects I/O stream.

This component is a physical resource shared by multiple application objects, which tend not to be active at the same time. Thus, this provides a level of virtual I/O capacity. A phase shift in the timing of I/O requites is provided by inserting very small delays in one or more I/O request streams, so that when those I/O requests proceed, they will do so without contention.

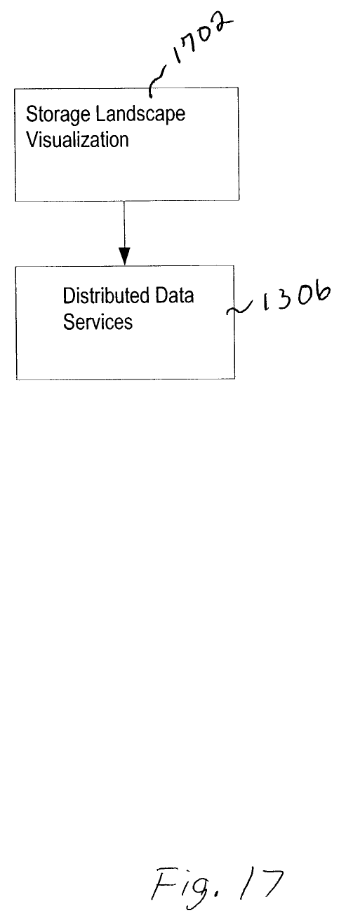

FIG. 17 depicts operational components relating to graphical display of system information.

Scientific Visualization of the Storage Landscape (“SLV”) 1702

This component is a facility to generate a Color, texture, 3-D topology/contour graphic representing variation in demand/capacity of the storage domain. It depends on DDS. Inputs are SAN topology with UOW∩UOS mappings. The output of the component is a graphic model.

This component provides an intuitive visual representation of ESFS Workflow NS with respect to resources allocated, workload levels, performance and utilization.

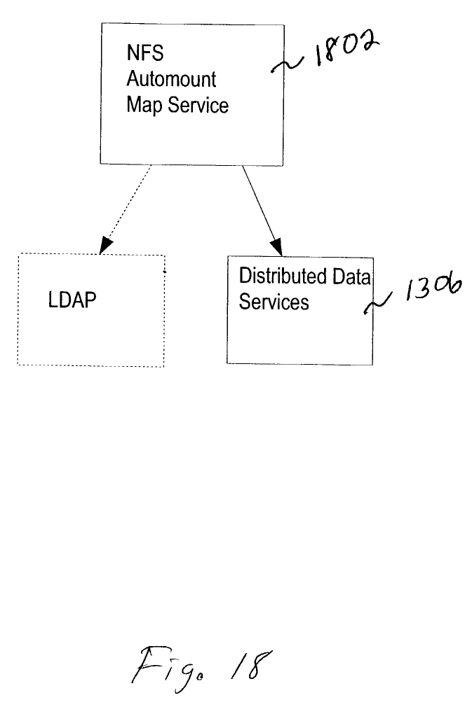

FIG. 18 depicts operational components relating to making the workflow name space available over NFS using NFS automount maps.

NFS Automount Map Service (“AMS”) 1802

This component provides a standard interface for mapping abstract name space to traditional NFS mounts and future IPFC virtual network connections for storage over IP. It depends on DDS and serves LDAP, NIS and NIS+. Inputs are ESFS Name space. The output of the component is Automount maps for resource access over NFS and FCIP.

This component provides a level of abstraction and leverage for shared access over standard resource mapping utility, the automount map facility of NFS. This service provides access to the WFNS over NFS.

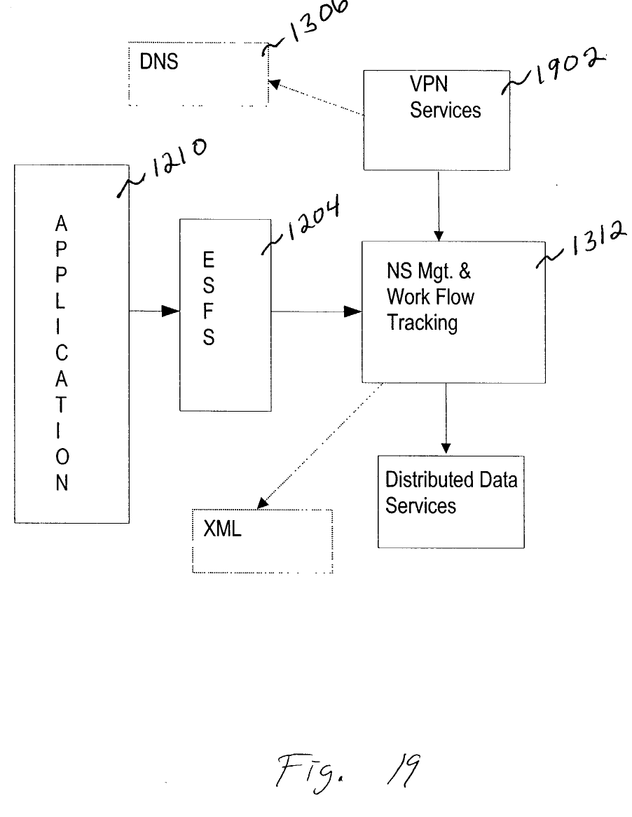

FIG. 19 depicts operational components relating to providing network access to the data storage management system.

VPN Services (“VPS”) 1902

This component provides access to the storage management facilities through a private secure IP network. It depends on WNS. Inputs are ESFS workflow name. The output of the component is VPN to private storage management IP network.

This component provides access control to the private storage management network.

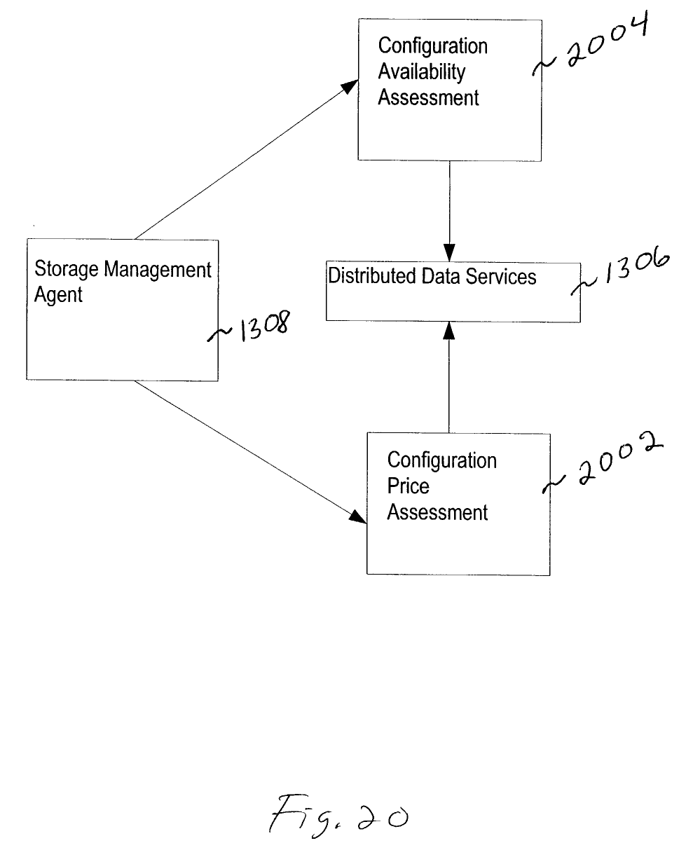

FIG. 20 depicts operational components relating to satisfying availability and price constraints.

Configuration Price Assessment (“CPA”) 2002

This component provides a means of differentiating configuration options with regard to price in addition to performance and availability considerations. It depends on DDS and serves SMA. Inputs are UOS. The output of the component is Estimated price.

The configuration design involves a balance of price, performance and availability. This module is used to provide a basis of price comparison in the decision process.

Configuration Availability Assessment (“CAA”) 2004

This component provides a means of differentiating configuration options with regard to availability in addition to performance and price considerations. It depends on DDS and serves SMA. Inputs are UOS. The output of the component is Estimated MTBF.

The configuration design involves a balance of price, performance and availability. This module is used to provide a basis of availability comparison in the decision process.

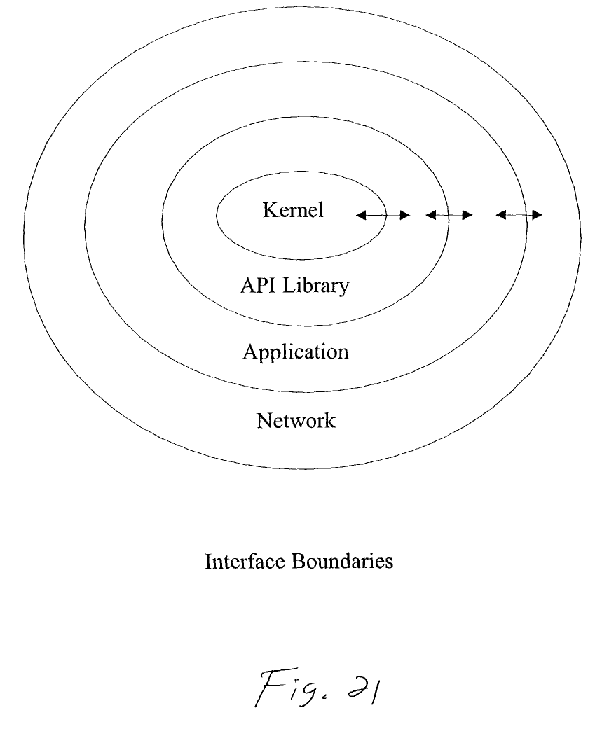

FIG. 21 depicts typical interface boundaries between process layers in a computing system. Thus, as represented by line 2110, kernel layer processes may communicate with API library layer processes. As represented by line 2112, API library layer processes may communicate with application layer processes and, as represented by line 2114, application layer process may communicate with network layer processes.

In one embodiment of the invention the process blocks of FIGS. 12-20 are associated with the process layers of FIG. 21 as follows: The file system encapsulation and the I/O scheduler may be associated with the kernel layer. The logical device configuration, storage management agent/broker, storage performance monitoring, file system encapsulation, security and access control, utilization and performance management, replication services, subscription workload, NFS automount map services and I/O scheduler may be associated with the API library layer. All of the process blocks may be associated with the application layer. All of the process blocks except for storage performance monitoring, file system encapsulation and I/O scheduler may be associated with the network layer.

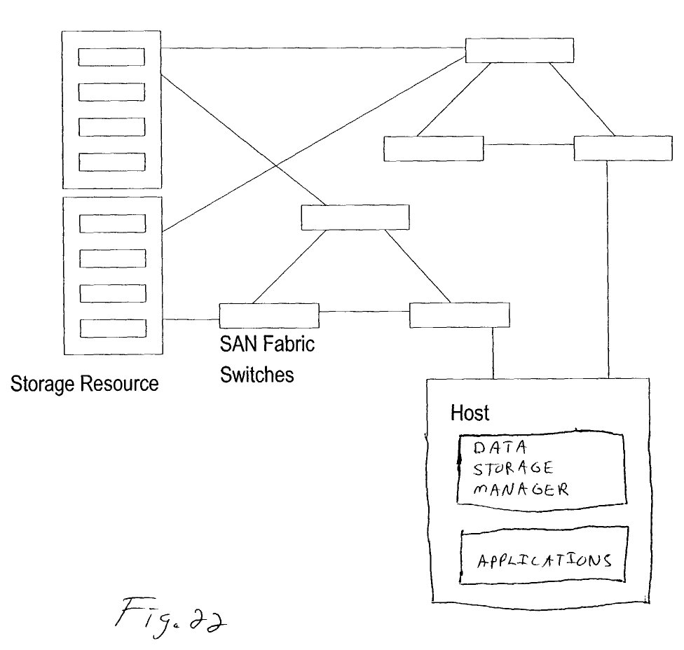

FIG. 22 depicts one embodiment of a distributed data storage system. Here, applications executing on a host processor access data storage resources through one or more SAN fabric switches. In accordance with one embodiment of the invention, a data storage manager may control the SAN fabric switches to allocate data storage resources for the application. As discussed herein, the criteria for determining matching storage resources and application workloads may depend on desired, measured and estimated response times for the application workloads.

In summary, the system may automate storage configuration design, resource provisioning, resource configuration, file system configuration and OS configuration of the I/O sub-system data path. The system may track application behavior over time, and tracks the capabilities of storage resources as they are introduced. Resources may be allocated with specific intent, based on application requirements, a service level specification, and accounting for the impact and interaction with other applications that may be sharing the resource.

Thus, the embodiments described herein may provide real-time determination of an application's I/O requirements, and map those requirements to the available storage resource, satisfying a system of price, availability, performance and utilization constraints. Service Level Specifications (“SLS”) may be achieved and maintained through deterministic, dynamic allocation and monitoring of storage resources. As a result, operation beyond the knee of the curve and associated costly interruptions of service may be avoided, while increased levels of I/O performance are achieved thereby providing higher productivity and increased system up-time.

It should be appreciated that the inventions described herein are applicable to and may utilize many different data storage systems.

It should also be appreciated that the inventions described herein may be constructed using a variety of physical components and configurations. For example, a variety of hardware and software processing components may be used to implement the functions and components described herein. These functions and components may be combined on one or more integrated circuits.

In addition, the components and functions described herein may be connected in many different ways. Some of the connections represented by the lead lines in the drawings may be in an integrated circuit, on a circuit board, over a backplane to other circuit boards, over a local network and/or over a wide area network (e.g., the Internet).

A wide variety of devices may be used to implement the data memories discussed herein. For example, a data memory may comprise one or more RAM, disk drive, SDRAM, FLASH or other types of data storage devices.

In one embodiment, the system designed leverages from and integrates into existing operating system capabilities. For example, UNIX facilities such as lex, yacc, rdist, make, sccs, and ndbm may be used. The use of private VPN technology allows a “trusted host” environment, with high security using standard network connections for the leverage of these utilities. Thus, a system design may exploit standard UNIX utilities in a trusted VPN.

In summary, the invention described herein teaches improved techniques for managing application workloads and data storage resources. While certain exemplary embodiments have been described in detail and shown in the accompanying drawings, it is to be understood that such embodiments are merely illustrative of and not restrictive of the broad invention. It will thus be recognized that various modifications may be made to the illustrated and other embodiments of the invention described above, without departing from the broad inventive scope thereof. In view of the above it will be understood that the invention is not limited to the particular embodiments or arrangements disclosed, but is rather intended to cover any changes, adaptations or modifications which are within the scope and spirit of the invention as defined by the appended claims.

What is claimed is:

1. A method of managing a data storage resource comprising:
defining a system of differential equations associated with I/O capacity of a data storage resource; and
mapping I/O demand to I/O capacity according to the system of differential equations.

2. The method of claim 1 wherein the system of differential equations is associated with probability distributions of applications associated with the data storage resource.

3. The method of claim 1 wherein mapping I/O demand to I/O capacity comprises spreading an application workload among a plurality of components of the data storage resource.

4. A method of characterizing a data storage resource comprising:
identifying at least one response characteristic of a data storage resource;
determining at least one probability distribution of application workloads associated with the data storage resource; and
determining a response time for at least one of the application workloads according to the at least one response characteristic and the at least one probability distribution.

5. The method of claim 4 wherein the at least one response characteristic defines, for the data storage resource, response times relative to load levels.

6. The method of claim 4 wherein the at least one probability distribution defines a percent of I/O activity associated with the data storage resource.

7. The method of claim 4 further comprising determining a utilization level of the data storage resource according to the response time.

8. A method of characterizing a data storage resource comprising:
generating a profile of a data storage resource;
determining a probability distribution of a workload associated with the data storage resource; and
determining a response time for a workload associated with the data storage resource according to the profile and the probability distribution.

9. The method of-claim 8 further comprising determining a utilization level of the data storage resource according to the response time.

10. A method of characterizing a data storage resource comprising:
generating a profile of a data storage resource;
determining a load level of the data storage resource;
determining a probability distribution of a workload associated with the data storage resource; and
determining I/O capacity for a workload associated with the data storage resource according to the profile, the load level and the probability distribution.

11. The method of claim 10 wherein determining I/O capacity further comprises determining I/O capacity according to an arrival rate.

12. A method of allocating a data storage resource comprising:
identifying a plurality of response characteristics of a data storage resource to a plurality of application workloads;
identifying a response time of the data storage resource to at least one of the application workloads; and
spreading the at least one application workload among a plurality of components in the data storage resource in accordance with the response time.

13. The method of claim 12 wherein spreading comprises defining a stripe width of a RAID data storage resource.

14. A method of characterizing a data storage resource comprising:
generating a profile of a data storage resource;
determining a load level of the data storage resource;
determining a probability distribution of a workload associated with the data storage resource;
determining I/O capacity for a workload associated with the data storage resource according to the profile, the load level and the probability distribution;
solving for a parameter according to the profile, the load level, the probability distribution and the I/O capacity.

15. The method of claim 14 wherein the parameter comprises a stripe width.

16. A method of allocating a data storage resource comprising:
monitoring I/O activity;
storing data associated with the monitored I/O activity;
defining at least one response characteristic of a data storage resource according to the stored data;
dividing an application workload among components of the data storage resource based on the stored data and the at least one response characteristic.

17. An encapsulated file system comprising:
at least one data storage resource;
at least one processor executing at least one application and an encapsulation layer process, wherein the encapsulation layer process monitors I/O activity associated with the at least one application and the at least one data storage resource.

18. The system of claim 17 wherein the at least one processor allocates the data storage resource according to the I/O activity.

19. An encapsulated file system comprising:
at least one operating system comprising at least one file system;
at least one virtual node structure associated with a process for modeling application workload; and
at least one virtual node structure associated with a data storage resource.

20. The system of claim 19 wherein, in response to a system call associated with the data storage resource, the at least one operating system invokes the process for modeling application workload.

21. A method of monitoring I/O activity comprising:
processing an I/O request;
redirecting the I/O request to a data monitoring process;
monitoring, by the data monitoring process, I/O activity associated with the I/O request; and
redirecting the I/O request to a data storage resource.

22. The method of claim 21 further comprising allocating a data storage resource to an application workload in response to the monitoring.

23. A workflow name space method comprising:
defining a workflow name space;
identifying at least one application workload associated with a data storage resource; and
associating the at least one application workload with the workflow name space.

24. The method of claim 23 wherein the workflow name space is associated with at least one operational structure of at least one business organization.

25. The method of claim 23 wherein identifying comprises identifying I/O activity associated with the at least one application.
